(19) United States
(12) Patent Application Publication
(10) Pub. No.: US 2026/0006278 A1
(43) Pub. Date: Jan. 1, 2026

(54) ELECTRONIC DEVICE AND CONTROL METHOD THEREFOR

(71) Applicant: Samsung Electronics Co., Ltd., Suwon-si (KR)

(72) Inventors: Eunjin LEE, Suwon-si (KR); Haeree NA, Suwon-si (KR); Haein LEE, Suwon-si (KR)

(21) Appl. No.: 19/317,876

(22) Filed: Sep. 3, 2025

Related U.S. Application Data
(63) Continuation of application No. PCT/KR2024/003224, filed on Mar. 13, 2024.

(30) Foreign Application Priority Data
Apr. 14, 2023 (KR) 10-2023-0049676

(51) Int. Cl. H04N 21/422; H04N 21/431

(52) U.S. Cl. CPC H04N 21/42208; H04N 21/4312

(57) ABSTRACT

An electronic device comprises a display, a communication interface, a memory for storing one or more instructions, and one or more processors connected to the display, the communication interface and the memory so as to control the electronic device. The one or more processors execute the one or more instructions so as to: identify information about content displayed on the display when a signal corresponding to a touch input of a user is received from an external input device through the communication interface; perform a first control operation on the basis of a touch input of the user if the content information is first content information; and, on the basis of the touch input of the user, perform a second control operation differing from the first control operation if the content information is second content information differing from the first content information.

### CROSS-REFERENCE TO RELATED APPLICATIONS

This application is a continuation of International Application No. PCT/KR2024/003224 designating the United States, filed on Mar. 13, 2024, in the Korean Intellectual Property Receiving Office and claiming priority to Korean Patent Application No. 10-2023-0049676, filed on Apr. 14, 2023, in the Korean Intellectual Property Office, the disclosures of each of which are incorporated by reference herein in their entireties.

### BACKGROUND

### Field

The disclosure relates to an electronic device and a control method therefor, and for example, to an electronic device that performs communication with an external device, and a control method therefor.

### Description of Related Art

Fueled by development of electronic technologies, various types of input devices are being developed. In particular, to meet the needs of users who want newer and more various functions, functions of input devices through which a user can easily control a subject to be controlled such as a touch device, etc. are developing more and more.

### SUMMARY

An electronic device according to various example embodiments of the disclosure may include: a display, a communication interface, comprising communication circuitry, memory configured to store at least one instruction, and at least one processor, comprising processing circuitry, connected with the display, the communication interface, and the memory, wherein at least one processor, individually and/or collectively, may be configured to execute the at least one instruction and to cause the electronic device to: based on receiving a signal corresponding to a touch input from an external input device through the communication interface, identify information on a content displayed on the display, and based on the information on the content being information on a first content, perform a first control operation based on the touch input, and based on the information on the content being information on a second content different from the information on the first content, perform a second control operation different from the first control operation based on the touch input.

According to various example embodiments, at least one processor, individually and/or collectively, may be configured to cause the electronic device to: based on continuously receiving a signal corresponding to the touch input by a specified time interval, identify the type of the touch input based on information on a plurality of touch coordinates included in the continuously received signals, perform the first control operation based on the identified type of the touch input and the information on the first content, and perform the second control operation based on the identified type of the touch input and the information on the second content.

According to various example embodiments, at least one processor, individually and/or collectively, may be configured to cause the electronic device to: based on the information on the content including information on a plurality of contents having different manipulation attributes, perform a control operation corresponding to the touch input based on information on a content wherein a selection GUI is located.

According to various example embodiments, at least one processor, individually and/or collectively, may be configured to cause the electronic device to: based on a real time broadcasting content being provided currently and the identified type of the touch input being identified as a swipe input, perform channel control based on the swipe input, and based on a web browser screen or a broadcasting program list being provided currently and the identified type of the touch input being identified as the swipe input, control a location of a pointer displayed on the display based on the swipe input.

According to various example embodiments, at least one processor, individually and/or collectively, may be configured to cause the electronic device to: based on identifying that a screen that was scrolled by greater than or equal to a threshold range being provided currently, and the touch input being identified as a touch input of a specified type, perform a control operation of restoring the scrolled screen to the original screen.

According to various example embodiments, at least one processor, individually and/or collectively, may be configured to cause the electronic device to: based on identifying that a single screen is being provided currently, and the touch input being identified as a touch input of a first type, perform a control operation of changing the single screen to a multi-view screen, and based on identifying that a multi-view screen is being provided currently, and the touch input being identified as a touch input of a second type, perform a control operation of changing the multi-view screen to a single screen.

An electronic device according to various example embodiments of the disclosure includes: a display including a touch panel, a communication interface comprising communication circuitry, memory configured to store at least one instruction, and at least one processor, comprising processing circuitry, connected with the display, the communication interface, and the memory, wherein at least one processor, individually and/or collectively, is configured to execute the at least one instruction and to cause the electronic device to: receive information on a content provided at an external device through the communication interface, and based on receiving a touch input through the touch panel, identify control information corresponding to the touch input based on the information on the content, and transmit a control signal corresponding to the identified control information to the external device through the communication interface.

According to various example embodiments, at least one processor, individually and/or collectively, may be configured to cause the electronic device to: provide at least one touch manipulation mode among a plurality of different touch manipulation modes based on the information on the content, wherein the plurality of different touch manipulation modes may include at least one of modes of which recognizable touch types are different or modes which generate different control signals for the same touch input type.

According to various example embodiments, at least one processor, individually and/or collectively, may be configured to cause the electronic device to: based on information on a content received from the external device including information on a plurality of contents having different manipulation attributes, provide a first touch manipulation mode corresponding to any one of the plurality of contents through the touch pad, and control the display to provide a GUI menu for changing the first touch manipulation mode to a second touch manipulation mode corresponding to another one of the plurality of contents, wherein the first touch manipulation mode and the second touch manipulation mode may be modes that generate control signals of different types for touch inputs of the same type.

According to various example embodiments, the memory may store information on a first control signal corresponding to a touch input of a first type in the first touch manipulation mode and information on a second control signal corresponding to a touch input of the first type in the second touch manipulation mode, and store information on a third control signal corresponding to a touch input of a second type in the second touch manipulation mode and information on a fourth control signal corresponding to a touch input of the second type in the second touch manipulation mode. At least one processor, individually and/or collectively, may be configured to cause the electronic device to: based on receiving a touch input of the first type in the first touch manipulation mode, transmit the first control signal to the external device through the communication interface, and based on receiving a touch input of the second type, transmit the second control signal to the external device through the communication interface, and based on receiving a touch input of the first type in the second touch manipulation mode, transmit the third control signal to the external device through the communication interface, and based on receiving a touch input of the second type, transmit the fourth control signal to the external device through the communication interface.

According to various example embodiments, at least one processor, individually and/or collectively, may be configured to cause the electronic device to: based on receiving a specified signal from the external device, provide a GUI menu for entering a touch manipulation mode, and based on receiving an instruction through the GUI menu, request information for provision of a touch manipulation mode to the external device, and based on receiving device information and the information on the content from the external device according to the request, control the display to provide a touch manipulation mode corresponding to the device information and the information on the content.

According to various example embodiments, at least one processor, individually and/or collectively, may be configured to cause the electronic device to: based on identifying that a real time broadcasting content is being provided at the external device based on the information on the content, control the display to provide a touch manipulation mode for manipulating the real time broadcasting content, and based on identifying that a broadcasting program list is being provided at the external device based on the information on the content, control the display to provide a touch manipulation mode for manipulating the broadcasting program list, wherein the touch manipulation mode for manipulating the real time broadcasting content and the touch manipulation mode for manipulating the broadcasting program list may be modes configured to generate control signals of different types for touch inputs of the same type.

According to various example embodiments, at least one processor, individually and/or collectively, may be configured to cause the electronic device to: based on identifying that a screen that was scrolled by greater than or equal to a threshold range is being provided at the external device based on the information on the content, and based on receiving a touch input of a specified type through the touch panel, transmit a control signal for restoring the scrolled screen to the original screen to the external device through the communication interface.

According to various example embodiments, at least one processor, individually and/or collectively, may be configured to cause the electronic device to: based on identifying that a single screen is being provided at the external device based on the information on the content, and based on receiving a touch input of a specified first type through the touch panel, transmit a control signal for changing the single screen to a multi-view screen to the external device through the communication interface; and based on identifying that a multi-view screen is being provided at the external device based ib the information on the content, and based on receiving a touch input of a specified second type through the touch panel, transmit a control signal for changing the multi-view screen to a single screen to the external device through the communication interface.

According to various example embodiments, at least one processor, individually and/or collectively, may be configured to cause the electronic device to: based on identifying that the external device is a projector device based on device information received from the external device, and based on receiving a touch input of a specified type and a specified direction through the touch panel, transmit a control signal for adjusting a size of a screen provided by the projector device to correspond to the specified direction to the external device through the communication interface.

According to various example embodiments, the external device may operate in one display mode from among a horizontal mode and a vertical mode, and at least one processor, individually and/or collectively, may be configured to cause the electronic device to: based on receiving mode information for a display mode of the external device from the external device, control the display to adjust a shape of a touch area wherein touch recognition is possible on the touch panel on the basis of the received mode information.

A method of controlling an electronic device including a touch panel according to various example embodiments of the disclosure includes: receiving information on a content provided at an external device from the external device, and based on receiving a touch input through the touch panel, identifying control information corresponding to the touch input based on the information on the content, and transmitting a control signal corresponding to the identified control information to the external device.

In a non-transitory computer-readable medium storing computer instructions which, when executed by at least one processor, comprising processing circuitry, of an electronic device including a touch panel, individually and/or collectively, cause the electronic device to perform operations including: receiving information on a content provided at an external device from the external device, and based on receiving a touch input through the touch panel, identifying control information corresponding to the touch input on the basis of the information on the content, and transmitting a control signal corresponding to the identified control information to the external device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A and FIG. 1B are diagrams for illustrating an example MDE environment according to various embodiments;

FIG. 2A is a block diagram illustrating an example configuration of an electronic device according to various embodiments;

FIG. 2B is a block diagram illustrating an example configuration of an electronic device according to various embodiments;

FIGS. 3A, 3B and 3C are diagrams illustrating an example touch manipulation method in a touch manipulation mode according to various embodiments;

FIG. 4 is a flowchart illustrating an example method of providing a touch manipulation mode of an electronic device according to various embodiments;

FIG. 5 is a diagram illustrating an example method of providing a touch manipulation mode according to various embodiments;

FIG. 6 is a flowchart illustrating an example method of entering a touch manipulation mode according to various embodiments;

FIGS. 7A, 7B, 7C and 7D are diagrams illustrating an example method of providing a menu for entering a touch manipulation mode according to various embodiments;

FIG. 8 is a flowchart illustrating an example method of converting a touch manipulation mode according to various embodiments;

FIGS. 9A and 9B are diagrams illustrating an example method of converting a touch manipulation mode according to various embodiments;

FIGS. 10A 10B are diagrams illustrating an example method of providing a touch manipulation mode according to various embodiments;

FIG. 11 is a flowchart illustrating an example method of converting a touch manipulation mode according to various embodiments;

FIGS. 12A, 12B, 12C and 12D are diagrams illustrating an example method of converting a touch manipulation mode according to various embodiments;

FIGS. 13A, 13B and 13C are diagrams illustrating an example method of converting a touch manipulation mode according to various embodiments;

FIGS. 14A and 14B are diagrams illustrating an example method of manipulating scrolling in a touch manipulation mode according to various embodiments;

FIGS. 15A, 15B and 15C are diagrams illustrating an example method of manipulating a projector screen in a touch manipulation mode according to various embodiments;

FIGS. 16A and 16B are diagrams illustrating an example method of manipulating a display mode of a display in a touch manipulation mode according to various embodiments;

FIGS. 17A and 17B are diagrams illustrating an example method of providing a touch manipulation mode according to a display mode of a display according to various embodiments;

FIG. 18 is a block diagram illustrating an example configuration of an electronic device according to various embodiments; and

FIG. 19 is a flowchart illustrating an example operation of an electronic device according to various embodiments.

### DETAILED DESCRIPTION

Hereinafter, the disclosure will be described in greater detail with reference to the accompanying drawings.

First, terms used in this disclosure will be described briefly, and then the disclosure will be described in greater detail.

As terms used in the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in some cases, there may be terms that were arbitrarily selected, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Terms such as ‘first,’ ‘second,’ and the like may be used to describe various elements, but the terms are not intended to limit the elements. The terms are used for the purpose of distinguishing one element from another element.

Singular expressions include plural expressions, unless defined clearly differently in the context. In the disclosure, terms such as “include” or “consist of” should be construed as designating that there are such characteristics, numbers, steps, operations, elements, components, or a combination thereof described in the disclosure, but not as excluding in advance the existence or possibility of adding one or more of other characteristics, numbers, steps, operations, elements, components, or a combination thereof.

The expression “at least one of A or B” should be interpreted to refer to any one of “A” or “B” or “A and B.”

In the disclosure, “a module” or “a part” performs at least one function or operation, and may be implemented as hardware or software, or as a combination of hardware and software. In addition, a plurality of “modules” or “parts” may be integrated into at least one module and implemented as at least one processor (not shown), except “a module” or “a part” that needs to be implemented as specific hardware.

Hereinafter, various example embodiments of the disclosure will be described in greater detail with reference to the accompanying drawings. However, it should be noted that the disclosure may be implemented in various different forms, and is not limited to the example embodiments described herein. In the drawings, parts that are not related to explanation may be omitted, for explaining the disclosure clearly, and throughout the disclosure, similar components are designated by similar reference numerals.

Hereinafter, various example embodiments of the disclosure will be described in greater detail with reference to the accompanying drawings.

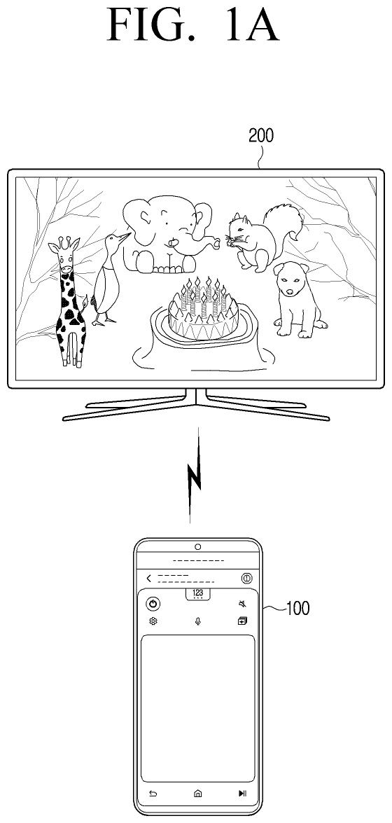

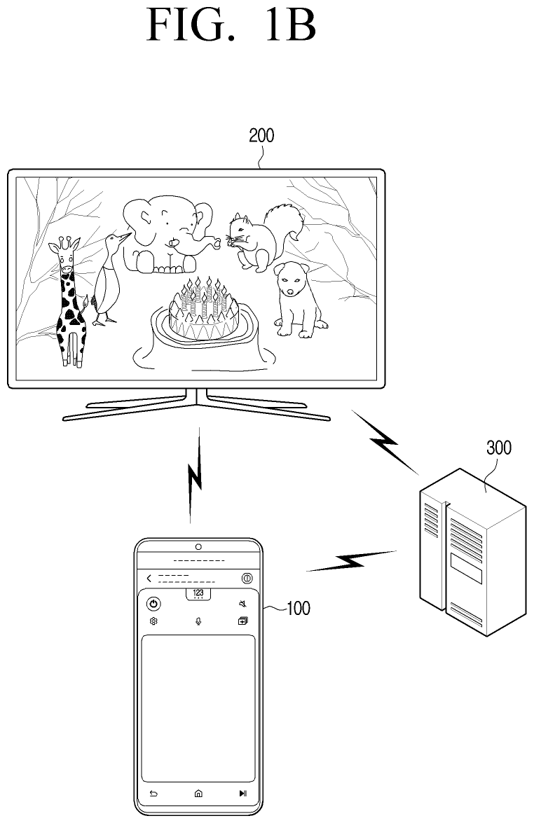

FIGS. 1A and 1B are diagrams illustrating an example MDE environment according to various embodiments.

A multi device experience (MDE) may refer, for example, to a user environment for providing differentiated experiences by incorporating the Internet of Things (IoT) and/or artificial intelligence (AI), etc. into several devices. For example, various services can be provided by communicatively connecting various types of devices such as, for example, and without limitation, a TV, a home appliance, a mobile device, a wearable device, etc.

According to an embodiment, a plurality of devices for providing an MDE environment, e.g., a first electronic device 100 and a second electronic device 200 can be implemented as various devices.

For example, the first electronic device 100 can be implemented as a user terminal including a touch pad. For example, the first electronic device 100 can be implemented as various devices that can remotely control the second electronic device 200 through a touch pad such as a smartphone, a tablet, a remote control wherein a touch pad is embedded, etc.

For example, the second electronic device 200 can be implemented as electronic devices having a display function such as a TV, a smart monitor, a projector, a desktop PC, a laptop PC, a PC, a portable multimedia player (PMP), a large format display (LFD), digital signage, a digital information display (DID), a video wall, a navigation, an AI speaker, etc. The second electronic device 200 can be implemented as home appliances having a display function such as a refrigerator, an air conditioner, an air purifier, an oven, a washing machine, etc.

The first electronic device 100 and the second electronic device 200 can communicate through various communication methods such as, not only wireless communication like Bluetooth communication, Wi-Fi communication, infrared communication, mobile communication, etc., but also wired communication, etc.

According to an embodiment, a case wherein the first electronic device 100 is implemented as a smartphone, and the second electronic device 200 is implemented as a TV as illustrated in FIG. 1A and FIG. 1B will be assumed. For example, the second electronic device 200 may be various Internet of Things (IoT) devices that can be controlled through an application installed in the first electronic device 100.

According to the embodiment illustrated in FIG. 1A, the first electronic device 100 and the second electronic device 200 may perform communication directly not via a separate server, and they may be implemented in a form wherein the second electronic device 200 can be controlled through the first electronic device 100. According to an embodiment, the first electronic device 100 and the second electronic device 200 may perform communication through a near field communication method such as Bluetooth communication, Wi-Fi direct communication, etc. For example, if a request for provision of a touch manipulation mode is received from the second electronic device 200, the first electronic device 100 may identify whether the second electronic device 200 is a device that was registered in advance (or paired in advance), and provide a touch manipulation mode according to the request for provision of a touch manipulation mode.

According to the embodiment illustrated in FIG. 1B, the first electronic device 100 and the second electronic device 200 may be in a state of having been registered in advance through a server 300. For example, the first electronic device 100 may install an IoT application for registering the second electronic device 200 to the server 300 and managing the second electronic device 200. The application is software that a user gets to use directly in an OS, and may be provided in the form of an icon interface on the screen of the first electronic device 100. According to an embodiment, the first electronic device 100 and the second electronic device 200 may be Internet of Things (IoT) devices that support a Wi-Fi module for communicating with the server 300. For example, a user may execute the IoT application on the first electronic device 100, and input a user account and log in to the server 300 through the input user account, and the first electronic device 100 may perform communication with the server 300 based on the logged-in user account. The server 300 may manage the second electronic device 200 registered to the user account. Here, the server 300 may be implemented as a cloud server, but is not limited thereto. For example, in case the second electronic device 200 is a device that was registered through the IoT application, the first electronic device 100 may provide a touch manipulation mode according to a request for provision of a touch manipulation mode of the second electronic device 200. Alternatively, if a user instruction for providing a touch manipulation mode for remotely controlling the second electronic device 200 is received through the IoT application, the first electronic device 100 may provide a touch manipulation mode.

Hereinafter, various example embodiments of providing different touch manipulation modes at the first electronic device 100 according to contents provided at the second electronic device 200 will be explained. The various example embodiments that will be described below may also be applied identically to a case of controlling the second electronic device 200 through a touch pad included in the second electronic device 200.

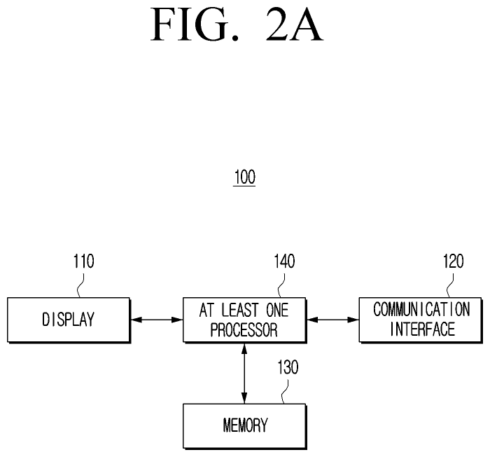

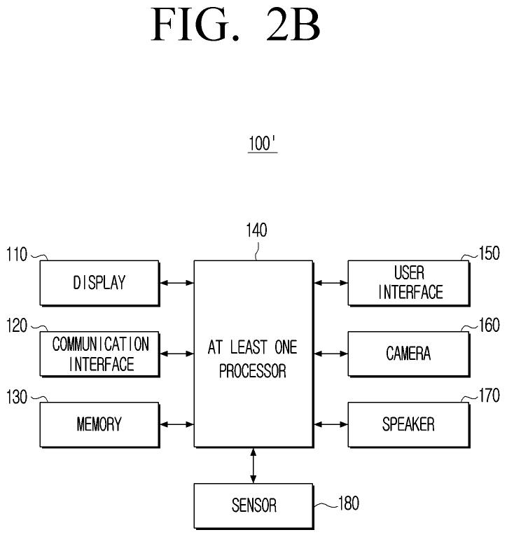

FIG. 2A is a block diagram illustrating an example configuration of an electronic device according to various embodiments.

According to FIG. 2A, the electronic device 100 includes a display 110, a communication interface (e.g., including communication circuitry) 120, memory 130, and at least one processor (e.g., including processing circuitry) 140.

The display 110 may be implemented as a display including self-luminous elements, or a display including non-self-luminous elements and a backlight. For example, the display 110 may be implemented as displays in various forms such as a liquid crystal display (LCD), an organic light emitting diodes (OLED) display, light emitting diodes (LEDs), micro LEDs, mini LEDs, a plasma display panel (PDP), a quantum dot (QD) display, quantum dot light emitting diodes (QLEDs), etc. Inside the display 110, driving circuits that may be implemented in forms such as an a-si TFT, a low temperature poly silicon (LTPS) TFT, an organic TFT (OTFT), etc., and a backlight unit, etc. may also be included together. According to an embodiment, on the front surface of the display 110, a touch sensor that has a form such as a touch film, a touch sheet, a touch pad, etc. and detects a touch operation may be arranged and implemented to detect various types of touch inputs. For example, the display 110 may detect various types of touch inputs such as a touch input by a user's hand, a touch input by an input device such as a stylus pen, a touch input by a specific electrostatic material, etc. Here, the input device may be implemented as an input device in a pen type that can be referred to as various terms such as an electronic pen, a stylus pen, an S-pen, etc. According to an embodiment, the display 110 may be implemented as a flat display, a curved display, a flexible display that can be folded and/or rolled, etc.

The communication interface 120 may be implemented as various interfaces including various circuitry according to implementation examples of the electronic device 100. For example, the communication interface 120 may perform communication with an external device, an external storage medium (e.g., a USB memory), an external server (e.g., a webhard), etc. through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc. Also, according to an embodiment, the communication interface 120 may perform communication with the external device 200.

The memory 130 may store data necessary for various embodiments. The memory 130 may be implemented in a form of memory embedded in the electronic device 100, or implemented in a form of memory that can be attached to or detached from the electronic device 100 according to the usage of stored data. For example, in the case of data for operating the electronic device 100, the data may be stored in memory embedded in the electronic device 100, and in the case of data for an extended function of the electronic device 100, the data may be stored in memory that can be attached to or detached from the electronic device 100. In the case of memory embedded in the electronic device 100, the memory may be implemented as at least one of volatile memory (e.g.: dynamic RAM (DRAM), static RAM (SRAM), or synchronous dynamic RAM (SDRAM), etc.) or non-volatile memory (e.g.: one time programmable ROM (OTPROM), programmable ROM (PROM), erasable and programmable ROM (EPROM), electrically erasable and programmable ROM (EEPROM), mask ROM, flash ROM, flash memory (e.g.: NAND flash or NOR flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

The at least one processor 140 may include various processing circuitry and controls the overall operations of the electronic device 100. Specifically, the at least one processor 140 may be connected with each component of the electronic device 100, and control the overall operations of the electronic device 100. For example, the at least one processor 140 may be electrically connected with the display 110 and the memory 130, and control the overall operations of the electronic device 100. The at least one processor 140 may include one or a plurality of processors.

The at least one processor 140 may perform the operations of the electronic device 100 according to various embodiments by executing the at least one instruction stored in the memory 130.

The at least one processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, and/or a machine learning accelerator. The at least one processor 140 may control one or a random combination of other components of the electronic device, and perform operations regarding communication or data processing. The at least one processor 140 may execute one or more programs or instructions stored in the memory. For example, the at least one processor 140 may perform the method according to an embodiment of the disclosure by executing the one or more instructions stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 140 may be implemented as a single core processor including one core, or may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and common cache shared by the plurality of cores may be included in the multicore processors. Each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In various embodiments of the disclosure, the processor may refer, for example, to a system on chip (SoC) wherein at least one processor and other electronic components are integrated, a single core processor, a multicore processor, or a core included in the single core processor or the multicore processor. The core may be implemented as a CPU, a GPU, an APU, a MIC, a DSP, an NPU, a hardware accelerator, or a machine learning accelerator, etc., but the example embodiments of the disclosure are not limited thereto. Hereinafter, the at least one processor 140 will be referred to as the processor 140, for the convenience of explanation. Thus, in summary, the processor 140 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

FIG. 2B is a block diagram illustrating an example configuration of an electronic device according to various embodiments.

According to FIG. 2B, the electronic device 100′ may include a display 110, a communication interface (e.g., including communication circuitry) 120, memory 130, at least one processor (e.g., including processing circuitry) 140, a user interface (e.g., including circuitry) 150, a camera 160, a speaker 170, and a sensor 180. Among the components illustrated in FIG. 2B, regarding components overlapping with the components illustrated in FIG. 2A, detailed explanation may not be repeated.

The user interface 150 may include various circuitry and be implemented as a device such as a button, a touch pad, a mouse, and a keyboard, or may be implemented as a touch screen that can perform the aforementioned display function and a manipulation input function together, etc.

The camera 160 may be turned on according to a predetermined event, and perform photographing. The camera 160 may convert a photographed image into an electrical signal, and generate image data based on the converted signal. For example, a subject may be converted into an electrical image signal through a semiconductor optical element (a charge coupled device (CCD)), and the image signal converted as such may be amplified and converted into a digital signal, and then go through signal processing. For example, the camera 160 may be implemented as a general camera, a stereo camera, a depth camera, etc.

The speaker 170 may be a component that outputs not only various kinds of audio data but also various kinds of notification sounds or voice messages, etc. The processor 140 may control the speaker 170 to output feedbacks or various kinds of notifications according to the various embodiments of the disclosure in audio forms.

The sensor 180 may include various types of sensors such as a touch sensor, a proximity sensor, an acceleration sensor (or a gravity sensor), a geomagnetic sensor, a gyro sensor, a pressure sensor, a position sensor, a distance sensor, an illumination sensor, etc.

Other than the above, the electronic device 100′ may include a microphone (not shown), a tuner (not shown), and a demodulator (not shown), etc. depending on implementation examples.

The microphone (not shown) is a component for receiving input of a user voice or other sounds, and converting them into audio data. However, according to an embodiment, the electronic device 100′ may receive a user voice input through an external device through the communication interface 110.

The tuner (not shown) may receive radio frequency (RF) signals by tuning a channel selected by a user in RF broadcast signals received through an antenna, or all pre-stored channels.

The demodulator (not shown) may receive a digital IF (DIF) signal converted at the tuner and demodulate the signal, and perform channel demodulation, etc.

According to various embodiments, the processor 140 may receive information on a content provided at an external device (e.g., FIG. 1, the second electronic device 200). If a touch input is received through the touch panel, the processor 140 may identify control information corresponding to the touch input based on the information on the content. Afterwards, the processor 140 may transmit a control signal corresponding to the identified control information to the external device.

According to various embodiments, information on a first control signal corresponding to a touch input of a first type in the first touch manipulation mode and information on a second control signal corresponding to a touch input of the first type in the second touch manipulation mode may be stored in the memory 130. Information on a third control signal corresponding to a touch input of a second type in the second touch manipulation mode and information on a fourth control signal corresponding to a touch input of the second type in the second touch manipulation mode may be stored in the memory 130. Information on a fifth control signal corresponding to a touch input of a third type that can be recognized in only any one of the first touch manipulation mode or the second touch manipulation mode may be stored in the memory 130.

According to various embodiments, if a touch input of the first type is received in the first touch manipulation mode, the processor 140 may transmit the first control signal to the external device 200, and if a touch input of the second type is received, the processor 140 may transmit the second control signal to the external device 200 based on the information stored in the memory 130. If a touch input of the first type is received in the second touch manipulation mode, the processor 140 may transmit the third control signal to the external device 200, and if a touch input of the second type is received, the processor 140 may transmit the fourth control signal to the external device 200 based on the information stored in the memory 130.

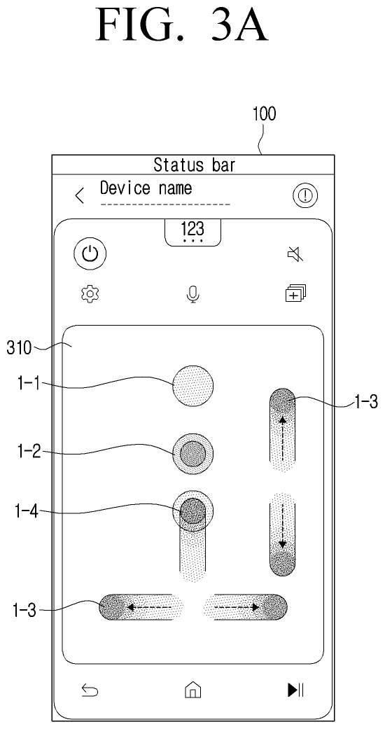

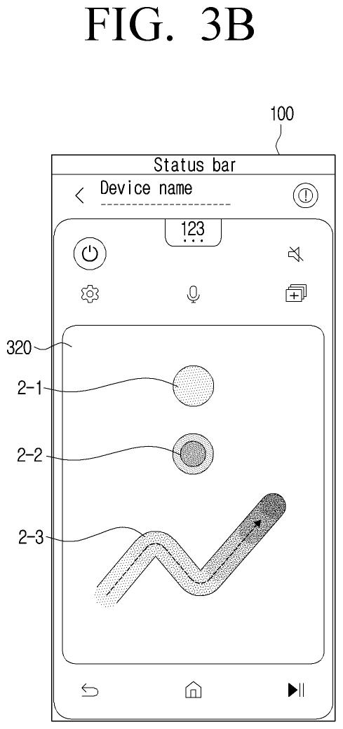

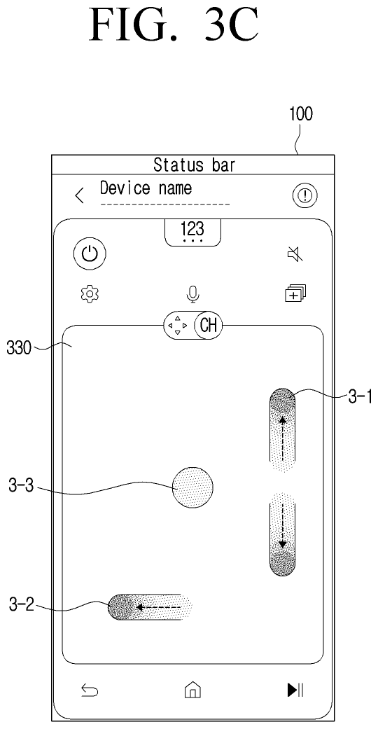

FIGS. 3A, 3B and 3C are diagrams illustrating an example touch manipulation method in a touch manipulation mode according to various embodiments.

According to an embodiment, the processor 140 may provide at least one touch manipulation mode among a plurality of different touch manipulation modes based on information on a content received from the external device 200. The touch manipulation mode may refer, for example, to a mode wherein the external device 200 can be controlled through a touch input through the touch panel.

According to an embodiment, the different touch manipulation modes may include at least one of a case wherein recognizable touch types are different or a case wherein different control signals are generated for the same touch input type. For example, in one touch manipulation mode, a tap and hold input may be recognized, but in another touch manipulation mode, a tap and hold input may not be recognized. The feature that a touch input of a specific type cannot be recognized may refer, for example, to a control signal corresponding to a touch input of the type cannot be generated, e.g., a control signal corresponding to a touch input of the type was not mapped in advance.

For example, in the different touch manipulation modes, different control signals may be generated for a touch input of the same type, e.g., a tap and hold input. For example, for a swipe input, a control signal moving the focus may be generated in one touch manipulation mode, and a control signal for a change of the channel may be generated in another touch manipulation mode.

According to an embodiment, screens according to the plurality of different touch manipulation modes may include an indicator indicating information of each touch manipulation mode. For example, in case a touch manipulation mode is a four direction manipulation mode, an indicator indicating that manipulation in four directions is possible may be provided on the screen. For example, in case a touch manipulation mode is a channel manipulation mode, an indicator indicating that manipulation of channels is possible may be provided on the screen.

FIG. 3A is a diagram illustrating a first touch manipulation mode according to an embodiment. According to an embodiment, in the first touch manipulation mode, a content screen provided on the external device 200 may be provided on a UI screen or an OTT screen. For example, in case content information received from the external device 200 is information indicating that the content screen is a UI screen or an OTT screen, the processor 140 may provide the first touch manipulation mode.

For example, a tap input 1-1 may correspond to control information which is “select,” and in accordance thereto, the processor 140 may generate a control signal corresponding to “select.” A tap and hold input 1-2 may correspond to control information which is the same as “an OK key on a hardware remote control,” and in accordance thereto, the processor 140 may generate a control signal corresponding to “an OK key on a hardware remote control.” A swipe input 1-3 may correspond to control information which is “move focus” (or move highlighter or move indicator), and in accordance thereto, the processor 140 may generate a control signal corresponding to “move focus.” A swipe and hold input 1-4 may correspond to control information which is “move focus continuously” (or move highlighter continuously or move indicator continuously), and in accordance thereto, the processor 140 may generate a control signal corresponding to “move focus continuously.”

FIG. 3B is a diagram illustrating a second touch manipulation mode according to an embodiment. According to an embodiment, the second touch manipulation mode may be provided in case a content screen provided on the external device 200 is a web browser screen or a workspace screen. For example, in case content information received from the external device 200 is information indicating that the content screen is a web browser screen or a workspace screen, the processor 140 may provide the second touch manipulation mode.

For example, a tap input 2-1 may correspond to control information which is “click,” and in accordance thereto, the processor 140 may generate a control signal corresponding to “click.” A tap and hold input 2-2 may correspond to control information which is “an OK key on a hardware remote control,” and in accordance thereto, the processor 140 may generate a control signal corresponding to “an OK key on a hardware remote control.” A swipe input 2-3 may correspond to control information which is the same as “mouse cursor movement,” and in accordance thereto, the processor 140 may generate a control signal corresponding to “mouse cursor movement.”

FIG. 3C is a diagram illustrating a third touch manipulation mode according to an embodiment. According to an embodiment, the third touch manipulation mode may be provided in case a content screen provided on the external device 200 is a screen that performs a function of relatively increasing or decreasing a value from the current value. For example, a content screen provided on the external device 200 may be a screen wherein channel manipulation is possible. For example, in case content information received from the external device 200 is information indicating that the content screen is a screen wherein channel manipulation is possible, the processor 140 may provide the third touch manipulation mode.

For example, a swipe up-down input 3-1 may correspond to control information which is “move to next big/small channel number,” and in accordance thereto, the processor 140 may generate a control signal corresponding to “move to next big/small channel number.” A swipe left input 3-2 may correspond to control information which is “go to previous channel,” and in accordance thereto, the processor 140 may generate a control signal corresponding to “go to previous channel.” A tap input 3-3 may correspond to control information which is the same as “open EPG” or “switch to 4D pad mode when EPG is displayed,” and in accordance thereto, the processor 140 may generate a control signal corresponding to the control information.

As described above, recognizable touch inputs in each touch manipulation mode and control information (or control signals) corresponding thereto may have been defined in advance and stored in the memory 130, and the processor 140 may generate control signals corresponding to touch inputs in each touch manipulation mode based on the pre-stored information. According to an embodiment, in case a touch input of a type that was not defined in advance is received in each touch manipulation mode, the processor 140 may provide a guide UI indicating that control corresponding to a touch input of the type is impossible. According to an embodiment, the processor 140 may provide a UI guiding a touch input similar to the type of the received touch input that was not defined in advance. According to an embodiment, the processor 140 may identify a touch input similar to the type of the received touch input that was not defined in advance among pre-defined touch input types, and provide a guide UI inquiring about whether to execute the identified touch input.

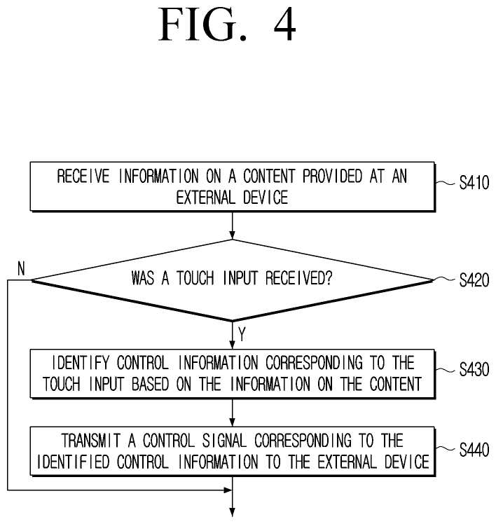

FIG. 4 is a flowchart illustrating an example method of providing a touch manipulation mode of an electronic device according various embodiments.

According to the embodiment illustrated in FIG. 4, the processor 140 may receive information on a content provided at an external device (e.g., FIG. 1, the second electronic device 200) in step S410. The content may include various kinds of information related to an image provided on the screen of the external device 200 such as an application, a reproduced image, UI elements, etc.

The information on the content may include information related to the type of the content, information related to the manipulation method of the content, and information on the configuration of the display of the content, and the provision state of the content, etc. For example, the information related to the type of the content may be information such as a user interface (UI) screen, an over the top (OTT) content screen, a web browser screen, a workspace screen, a real time broadcasting content screen, a VOD content reproduction screen, etc.

The information related to the manipulation method of the content may be information related to various manipulation methods such as manipulation in up/down/left/right directions, manipulation in up/down directions, manipulation in left/right directions, manipulation of selection, manipulation of reproduction, manipulation of a time point of reproduction, manipulation of start of reproduction, manipulation of end of reproduction, etc. Manipulation methods of contents may vary according to types of contents, but the disclosure is not necessarily limited thereto. That is, even if types of contents are different, the manipulation method of the contents may be the same, and even if the type of contents is the same, the manipulation methods of the contents may be different. The configuration of the display of the content may include information such as an arrangement state, the number, the sizes, etc. of a plurality of UI elements. The provision state of the content may include information such as whether the content can be reproduced, whether the content can be moved, etc.

If a touch input is received through the touch panel in step S420: Y, the processor 140 may identify control information corresponding to the touch input based on the information on the content in step S430. According to an embodiment, if a touch input is received through the touch panel, the processor 140 may identify control information corresponding to the touch input based on the type information of the content. The touch input may include various types of touch inputs such as a tap input, a tap and hold input, a swipe input, a swipe and hold input, a click input, etc. For example, if a swipe input is received through the touch panel, the processor 140 may identify control information corresponding to the swipe input based on the type information of the content.

The processor 140 may transmit a control signal corresponding to the identified control information to the external device in step S440. According to an embodiment, if control information corresponding to a touch input identified based on the type information of the content is control information for channel up, the processor 140 may transmit a control signal (e.g., a remote control signal) corresponding to the control information to the external device.

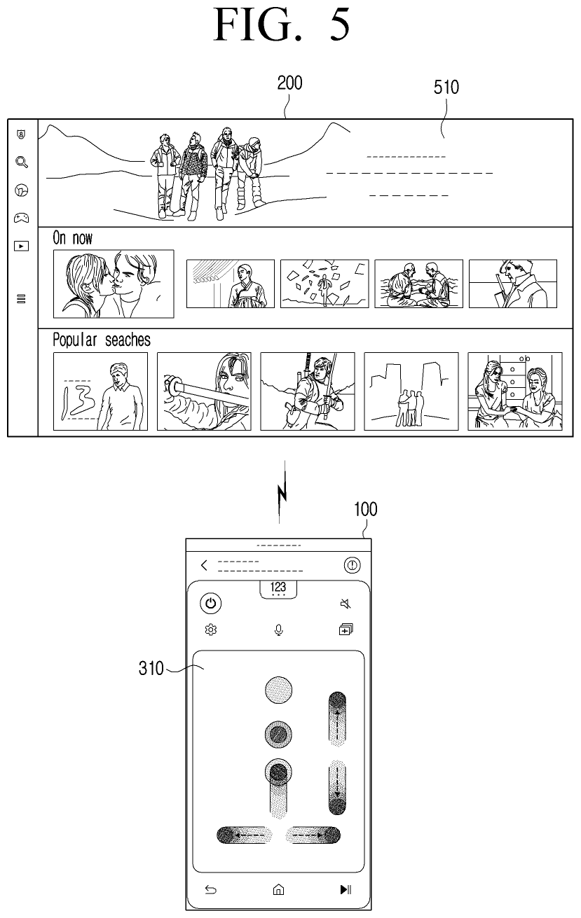

FIG. 5 is a diagram illustrating an example method of providing a touch manipulation mode according to various embodiments.

According to the embodiment illustrated in FIG. 5, while a UI screen 510 is being provided on the external device 200, the external device 200 may transmit content information indicating that the UI screen 510 is being provided to the electronic device 100 according to a predetermined event. Here, the predetermined event may include various events wherein the external device 200 can recognize that a touch manipulation mode will be executed in the electronic device 100 such as a request of the electronic device 100, an event wherein a specific app is executed in the electronic device 100, etc.

When the content information indicating that the UI screen 510 is being provided is received from the external device 200, the processor 140 may provide a touch manipulation mode 310 corresponding to the UI screen 510. For example, the processor 140 may provide a first touch manipulation mode 310 as illustrated in FIG. 3A. In the first touch manipulation mode 310, recognizable touch types, and control information corresponding to each touch type may have been set in advance. The feature that recognizable touch types have been set in advance may refer, for example, to the processor 140 may ignore touch types other than the touch types set in advance. For example, as explained in FIG. 3A, the processor 140 may recognize a tap input 1-1, a tap and hold input 1-2, a swipe input 1-3, and a swipe and hold input 1-4 set in advance in the first touch manipulation mode 310, and identify control information corresponding thereto.

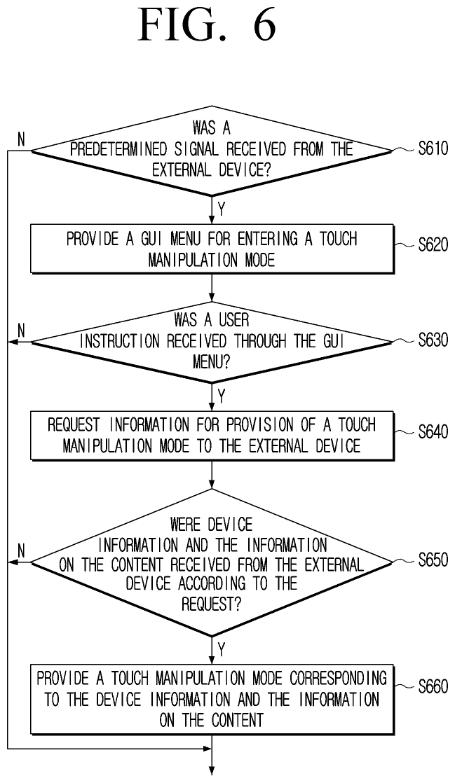

FIG. 6 is a flowchart illustrating an example method of entering a touch manipulation mode according to various embodiments.

Referring to FIG. 6, if a predetermined signal is received from the external device 200 in step S610: Y, the processor 140 may provide a GUI menu for entering a touch manipulation mode in step S620. According to an embodiment, if a broadcasting signal is received from the external device 200, the processor 140 may identify whether the external device 200 is a device that was registered in advance (or paired in advance) based on information of the external device 200 included in the received signal. If the external device 200 is identified as a pre-registered device, the processor 140 may provide a GUI menu for entering a touch manipulation mode. For example, the pre-registered device may be a device that was registered according to various services such as an IoT, an MDE, the same account, etc.

According to an embodiment, if it is identified that the external device 200 is not a pre-registered device, the processor 140 may identify whether there is a connection history with the external device 200. If a connection history with the external device 200 is identified, the processor 140 may provide a GUI menu for entering a touch manipulation mode. For example, the connection history may be a connection history according to various services such as mirroring, casting, etc.

According to an embodiment, the GUI menu may be provided in various forms according to the state of the electronic device 100. For example, the GUI menu may be an application or a floating menu provided on the screen of the electronic device 100. For example, the GUI menu may be a GUI menu wherein the screen of the electronic device 100 is provided on a lock screen or a quick panel.

If a user instruction is received through the GUI menu in step S630: Y, the processor 140 may request information for provision of a touch manipulation mode to the external device 200 in the step S640. The information for provision of a touch manipulation mode may include device information and information on the content. However, in case device information was received in step S610, the information for provision of a touch manipulation mode may include only information on the content.

If the device information and the information on the content are received from the external device 200 according to the request in step S650: Y, the processor 140 may provide a touch manipulation mode corresponding to the device information and the information on the content in the step S660.

According to an embodiment, the processor 140 may provide a touch manipulation mode based on content information such as the type of a content, etc. According to an embodiment, the processor 140 may provide a touch manipulation mode based on device information such as the type of a device (e.g., a TV, a projector, etc.), the size of a device screen, etc., and content information such as the type of a content, etc.

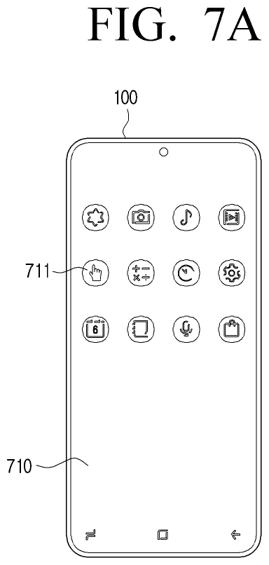

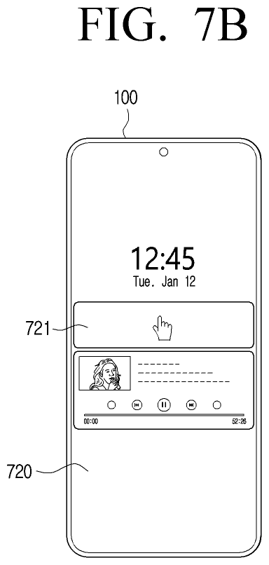

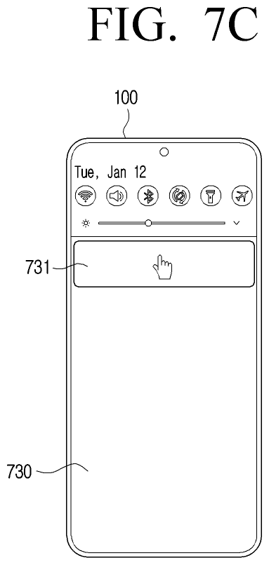

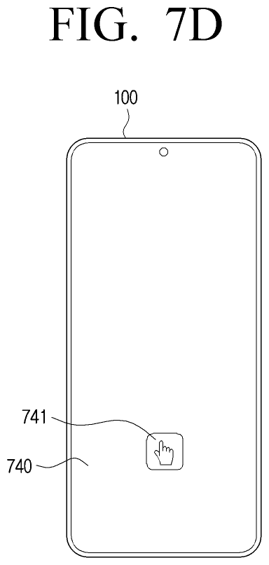

FIGS. 7A, 7B, 7C and 7D are diagrams illustrating an example method of providing a menu for entering a touch manipulation mode according to various embodiments.

FIG. 7A is a diagram illustrating a case wherein a GUI menu is provided as an icon type 711 corresponding to an application on a screen 710 of the electronic device 100 according to an embodiment. For example, the application may be an IoT application for registering the electronic device 100 and the external device 200 to the server 300, and managing the devices. The application is software that a user gets to use directly in the OS, and may be provided in the form of an icon interface on the screen of the electronic device 100.

FIG. 7B is a diagram illustrating a case wherein a GUI menu is provided as the same type 721 as a UI provided on a lock screen 720 of the electronic device 100 according to an embodiment.

FIG. 7C is a diagram illustrating a case wherein a GUI menu is provided as the same type 731 as a UI provided on a quick panel 730 of the electronic device 100 according to an embodiment.

FIG. 7D is a diagram illustrating a case wherein a GUI menu is provided as a floating menu type 741 on a screen 740 of the electronic device 100 according to an embodiment.

According to an embodiment, in FIG. 7A to FIG. 7D, it was illustrated that a specific indicator (e.g., a hand shape indicating a touch manipulation) is included in the GUI menu, but a form of an indicator may be diverse, and may include at least one of an image or a text indicating that the electronic device 100 can enter a touch manipulation mode.

According to various embodiments, if a user instruction is received through a GUI menu illustrated in any one of FIG. 7A to FIG. 7D, the electronic device 100 may enter a touch manipulation mode for controlling the external device 200.

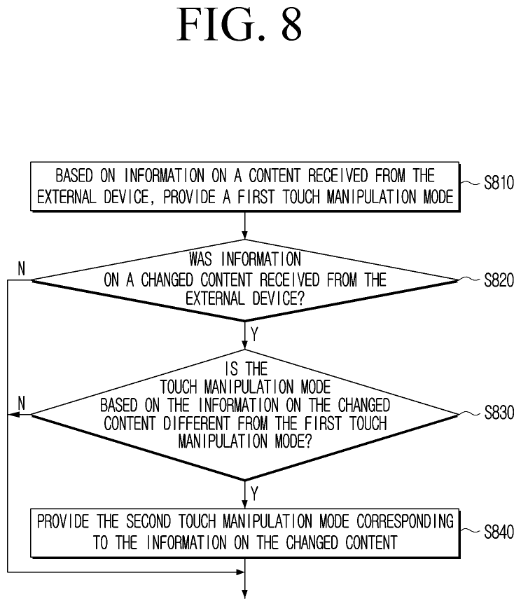

FIG. 8 is a flowchart illustrating an example method of converting a touch manipulation mode according to various embodiments.

According to the embodiment illustrated in FIG. 8, the processor 140 may provide the first touch manipulation mode based on information on a content received from the external device 200 in step S810. For example, if it is identified that the touch manipulation mode for manipulating the content displayed on the external device 200 is the first touch manipulation mode (e.g., FIG. 3A) based on the information received from the external device 200, the processor 140 may generate a control signal based on the first touch manipulation mode for a user touch input received through the touch panel.

If information on a changed content is received from the external device in step S820: Y, the processor 140 may identify whether the touch manipulation mode based on the information on the changed content is different from the first touch manipulation mode in step S830. For example, the processor 140 may identify whether the touch manipulation mode for manipulating the changed content that is displayed on the external device 200 is different from the first touch manipulation mode (e.g., FIG. 3A) based on the information received from the external device 200.

If it is identified that the touch manipulation mode based on the information on the changed content is different from the first touch manipulation mode in step S830: Y, the processor 140 may provide the second touch manipulation mode corresponding to the information on the changed content in step S840. For example, if it is identified that the touch manipulation mode for manipulating the changed content that is displayed on the external device 200 is the second touch manipulation mode (e.g., FIG. 3B), the processor 140 may generate a control signal based on the second touch manipulation mode for a user touch input received through the touch panel.

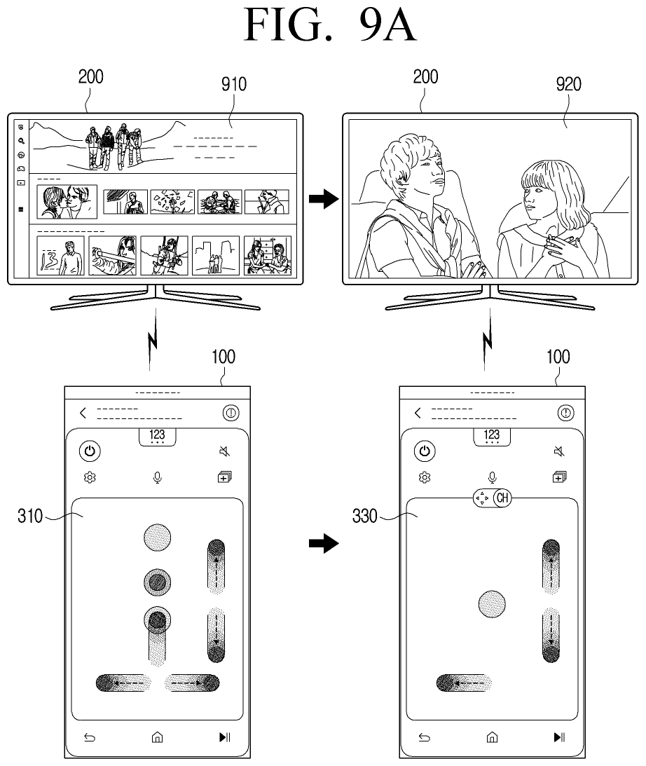

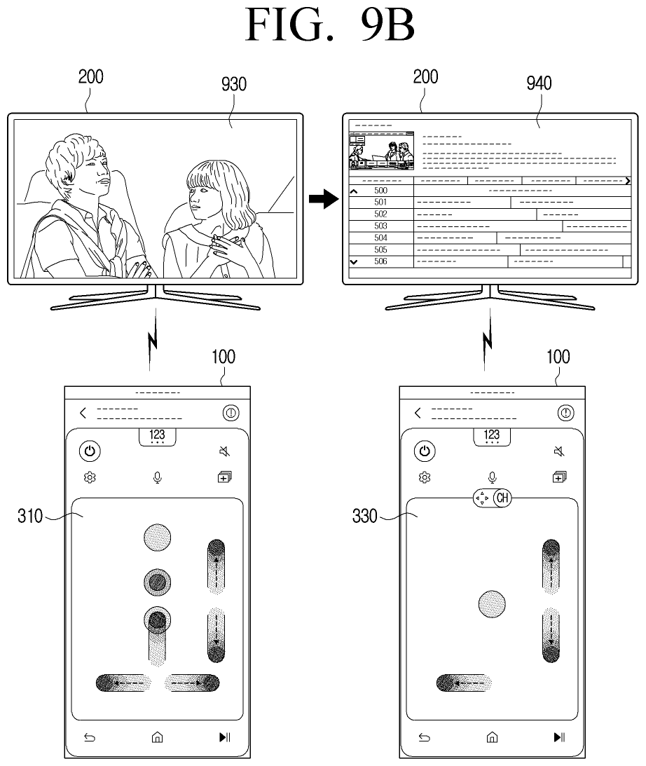

FIGS. 9A and 9B are diagrams illustrating an example method of converting a touch manipulation mode according to various embodiments.

The drawing in the upper left part of FIG. 9A illustrates a case wherein a UI screen including a plurality of graphic user interface (GUI) items is provided on the external device 200. In this case, the external device 200 may transmit, to the electronic device 100, information indicating that a UI screen including a plurality of GUI items and a focus GUI 910 is being provided to the electronic device 100 according to a request of the electronic device 100. The electronic device 100 may provide the first touch manipulation mode 310 for manipulating the UI screen based on the received information. The GUI items may include images and/or texts in various forms corresponding to various types of contents such as an image content, a video content, an application, an advertising content, etc. For example, the GUI items may be a thumbnail, a representative image, a title, description, etc. representing the content, but they are not limited if they are in forms by which identification of the content is possible.

For example, the electronic device 100 may provide the first touch manipulation mode wherein a tap input 1-1, a tap and hold input 1-2, a swipe input 1-3, and a swipe and hold input 1-4 can be recognized, and corresponding control signals can be generated as illustrated in the left lower part of FIG. 9A. For example, for the tap input 1-1, the electronic device 100 may generate a control signal corresponding to “select,” and for the tap and hold input 1-2, the electronic device 100 may generate a control signal corresponding to “an OK key on a hardware remote control.”

For the swipe input 1-3, the electronic device 100 may generate a control signal corresponding to “move focus,” and for the swipe and hold input 1-4, the electronic device 100 may generate a control signal corresponding to “move focus continuously.” According to an embodiment, in case a touch input other than the tap input 1-1, the tap and hold input 1-2, the swipe input 1-3, and the swipe and hold input 1-4, e.g., a touch input of a type that was not defined in advance in the first touch manipulation mode is received, the processor 140 may provide at least one of a guide UI indicating that control corresponding to a touch input of the type is impossible, a UI guiding a touch input similar to the type of the received touch input, or a guide UI inquiring about whether to execute a touch input similar to the type of the received touch input that was not defined in advance among the pre-defined touch input types.

According to an embodiment, if the content provided at the external device 200 is changed, the external device 200 may transmit information on the changed content to the electronic device 100. For example, in case the provided content was changed as a specific content was selected on the UI screen and reproduced, the external device 200 may transmit information on the changed content to the electronic device 100. For example, the external device 200 may transmit the information on the changed content to the electronic device 100 according to a request of the electronic device 100.

The drawing in the upper right part of FIG. 9A illustrates a case wherein a content reproduction screen 920 is provided on the external device 200. In this case, according to a request of the electronic device 100 or an event wherein the content is changed, the external device 200 may transmit, to the electronic device 100, information indicating that a content reproduction screen is being provided to the electronic device 100. The electronic device 100 may provide a third touch manipulation mode 330 for manipulating the content reproduction screen based on the received information.

For example, the electronic device 100 may provide the third touch manipulation mode wherein a swipe up-down input 3-1, a swipe left input 3-2, and a tap input 3-3 can be recognized, and corresponding control signals can be generated as illustrated in the lower right part of FIG. 9A. For example, for the swipe up-down input 3-1, the electronic device 100 may generate a control signal corresponding to “move to next big/small channel number.” Also, for the swipe left input 3-2, the electronic device 100 may generate a control signal corresponding to “go to previous channel.” In addition, for the tap input 3-3, the electronic device 100 may generate a control signal corresponding to “open EPG” or “switch to 4D pad mode when EPG is displayed.”

The drawing in the upper left part of FIG. 9B illustrates a case wherein a broadcasting content screen 930 is provided on the external device 200. In this case, the external device 200 may transmit, to the electronic device 100, information indicating that a broadcasting content screen is being provided to the electronic device 100 according to a request of the electronic device 100. In this case, the electronic device 100 may provide the first touch manipulation mode 310 for manipulating the UI screen based on the received information as illustrated in the lower left part of FIG. 9B.

According to an embodiment, if the broadcasting content provided on the external device 200 is changed to an EPG content, the external device 200 may transmit information on the changed content to the electronic device 100. The drawing in the right upper part of FIG. 9B illustrates a case wherein an EPG screen 940 is provided on the external device 200. In this case, according to a request of the electronic device 100 or an event wherein the content is changed, the external device 200 may transmit, to the electronic device 100, information indicating that an EPG screen is being provided to the electronic device 100. The electronic device 100 may provide the third touch manipulation mode 330 for manipulating the EPG screen based on the received information. As the operations in the first touch manipulation mode 310 and the third touch manipulation mode 330 are identical/similar to the operations explained in FIG. 9A, detailed explanation may not be repeated here.

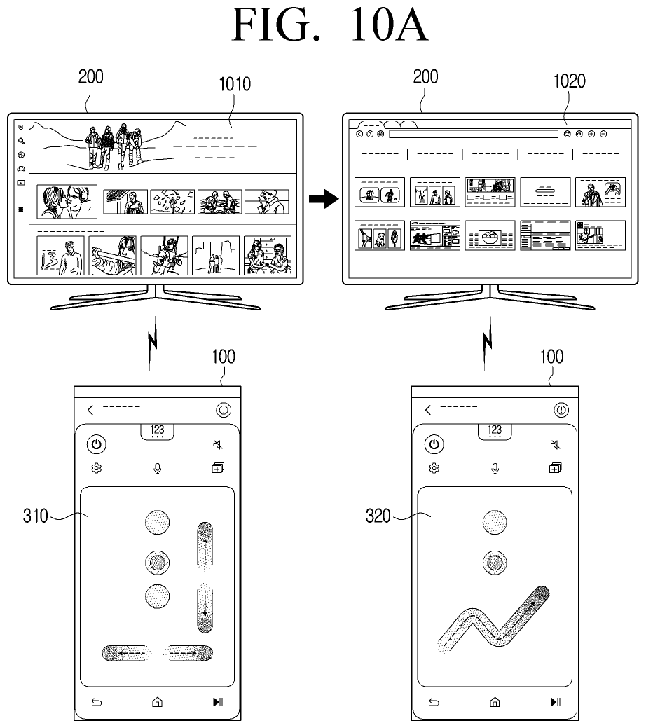

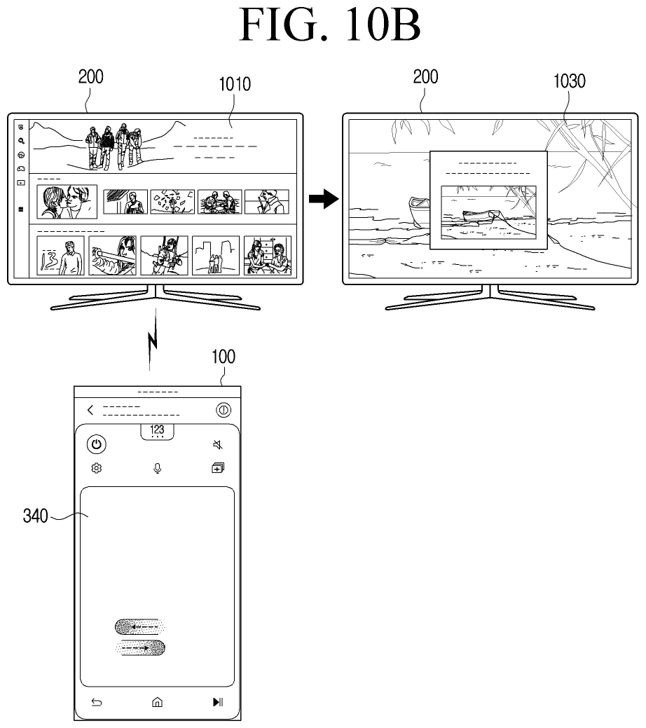

FIGS. 10A and 10B are diagrams illustrating an example method of providing a touch manipulation mode according to various embodiments.

The drawing in the upper left part of FIG. 10A illustrates a case wherein a UI screen 1010 including a plurality of graphic user interface (GUI) items is provided on the external device 200. In this case, the external device 200 may transmit, to the electronic device 100, information indicating that a UI screen including a plurality of GUI items and a focus GUI is being provided to the electronic device 100 according to a request of the electronic device 100. In this case, the electronic device 100 may provide the first touch manipulation mode 310 for manipulating the UI screen based on the received information as illustrated in the lower left part of FIG. 10A.

According to an embodiment, if the content provided at the external device 200 is changed, the external device 200 may transmit information on the changed content to the electronic device 100. For example, in case the content screen was changed from a UI screen to a web browser screen, the external device 200 may transmit information on the changed content to the electronic device 100. For example, the external device 200 may transmit the information on the changed content to the electronic device 100 according to a request of the electronic device 100.

The drawing in the upper right part of FIG. 10A illustrates a case wherein a web browser screen 1020 is provided on the external device 200. In this case, according to a request of the electronic device 100 or an event wherein the content is changed, the external device 200 may transmit, to the electronic device 100, information indicating that a web browser screen is being provided to the electronic device 100. The electronic device 100 may provide the second touch manipulation mode 320 for manipulating the content reproduction screen based on the received information. For example, the electronic device 100 may provide the second touch manipulation mode wherein a tap input 2-1, a tap and hold input 2-2, and a swipe input 2-3 can be recognized, and corresponding control signals can be generated as illustrated in the right lower part of FIG. 10A. However, this is merely an example, and the first touch manipulation mode may be maintained according to the configuration of the web browser screen.

According to an embodiment, as illustrated in FIG. 10B, the electronic device 100 may provide a fourth touch manipulation mode 340 for provision of an always on display (AOD) mode according to the type of a screen provided on the external device 200. For example, in case a UI screen 1010, a web browser screen, etc. are provided on the external device 200, the electronic device 100 may provide the fourth touch manipulation mode 340 for provision of the always on display (AOD) mode as illustrated in the lower left part of FIG. 10. For example, according to swiping touch inputs in left/right directions in the fourth touch manipulation mode 340, the electronic device 100 may control movement/conversion between the current screen and the AOD screen of the external device 200. However, depending on embodiments, touch inputs for movement/conversion between the current screen and the AOD screen may be implemented such that they can be input simultaneously in the first touch manipulation mode 310 to the third touch manipulation mode 330 but not a separate touch manipulation mode.

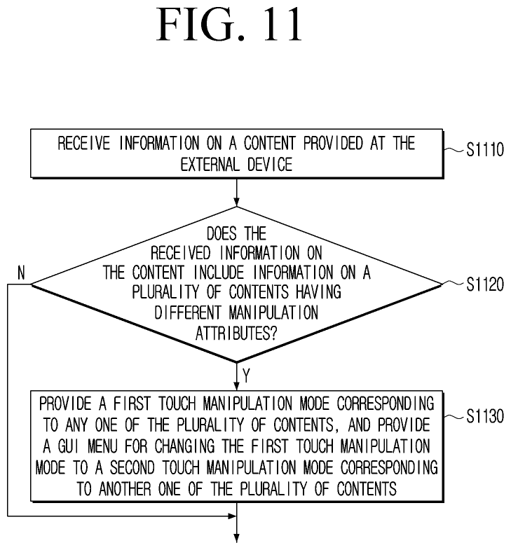

FIG. 11 is a flowchart illustrating an example method of converting a touch manipulation mode according to various embodiments.

Referring to FIG. 11, the processor 140 may receive information on a content from the external device in step S1110.

The processor 140 may identify whether the received information on the content includes information on a plurality of contents having different manipulation attributes in step S1120.

In case the received information on the content includes information on a plurality of contents having different manipulation attributes in step S1120: Y, the processor 140 may provide a first touch manipulation mode corresponding to any one of the plurality of contents through the touch pad, and provide a GUI menu for changing the first touch manipulation mode to a second touch manipulation mode corresponding to another one of the plurality of contents in step S1130. According to an embodiment, priorities for the plurality of contents may have been set in advance, and the processor 140 may provide a touch manipulation mode corresponding to a content having a high priority, and at the same time, provide a tap menu (or an option menu) through which the user can change the touch manipulation mode.

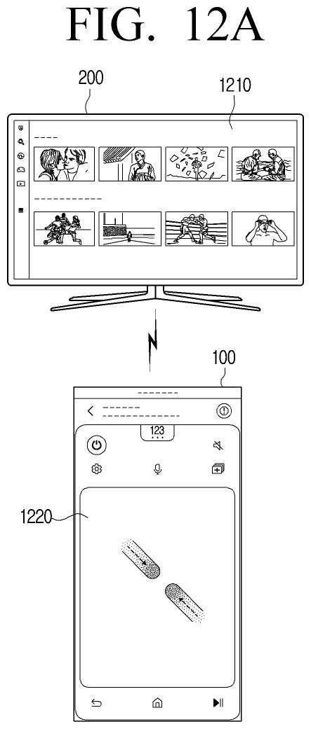

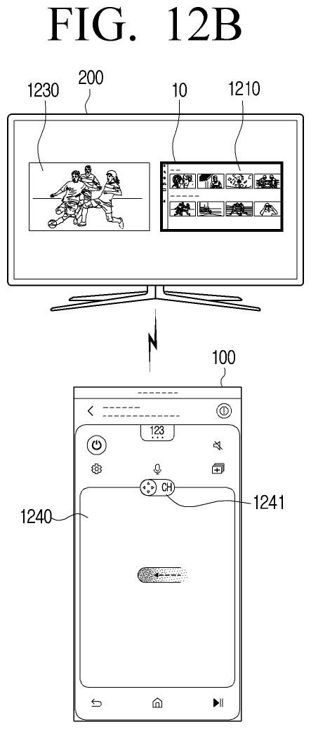

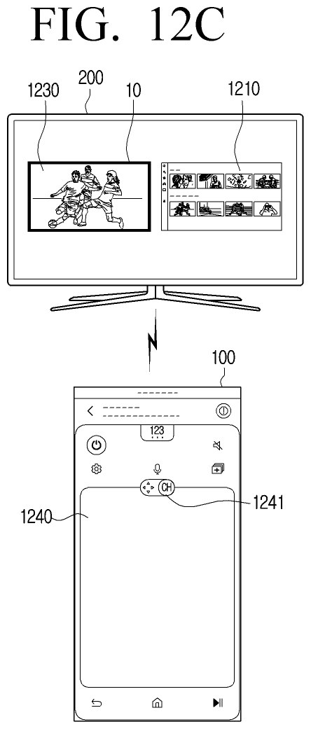

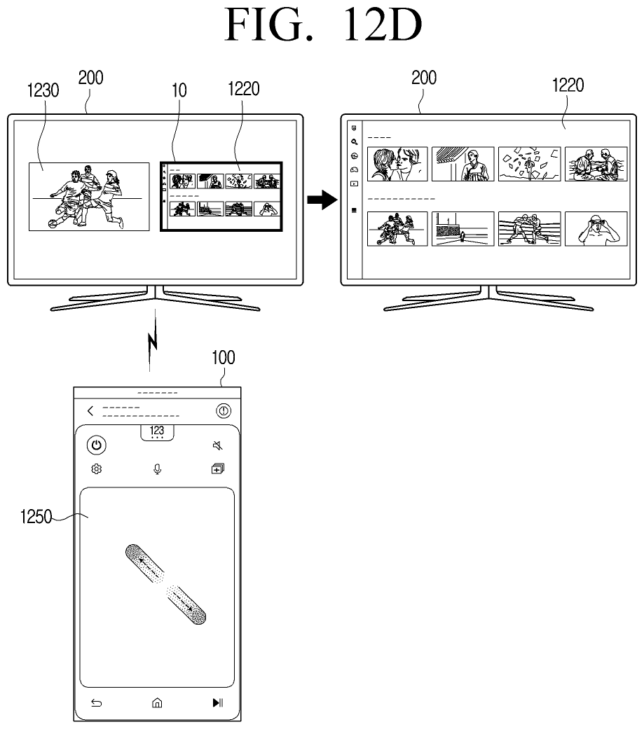

FIGS. 12A, 12B, 12C and 12D are diagrams illustrating an example method of converting a touch manipulation mode according to various embodiments.

According to various embodiments, if it is identified that a single screen is being provided at the external device 200 based on information on a content received from the external device 200, and a touch input of a predetermined first type is received, the electronic device 100 may transmit a control signal for changing the single screen to a multi-view screen to the external device 200. If it is identified that a multi-view screen is being provided at the external device 200 based on the information on the content received from the external device 200, and a touch input of a predetermined second type is received, the electronic device 100 may transmit a control signal for changing the multi-view screen to a single screen to the external device 200.

According to various embodiments, while a single screen or a multi-view screen is being provided at the external device 200, if a pinch zoom out input or a pinch zoom in input is received at the electronic device 100, the electronic device 100 may transmit a control signal for converting the single screen to a multi-view screen, or converting the multi-view screen to a single screen to the external device 200.

According to FIG. 12A, while a signal screen 1210 (e.g., an OTT UI screen) is being provided at the external device 200, a touch input of a specific type, e.g., a pinch zoom out input may be received at the electronic device 100. For example, the external device 200 may transmit information indicating that the single screen 1210 is being provided to the electronic device 100, and the electronic device 100 may provide a touch manipulation mode 1220 corresponding thereto. In this case, the electronic device 100 may transmit a control signal for changing the single screen 1210 to a multi-view screen to the external device 200.

In this case, as illustrated in the upper part of FIG. 12B, the single screen 1210 may be changed to a multi-view screen including a plurality of content screens 1210, 1230 at the external device 200. For example, a multi-view screen including a content thumbnail screen (or a content selection screen) 1210 that was originally being provided, and a content screen 1230 selected by a pointer (or a cursor or an indicator) on the content thumbnail screen 1210 may be provided. For example, the multi-view screen may include a pointer (or a cursor or an indicator) 10 for selecting one of the plurality of content screens 1210, 1230. In this case, the external device 200 may transmit information indicating that the multi-view screen is being provided to the electronic device 100.

In this case, as illustrated in the lower part of FIG. 12B, a touch manipulation mode 1240 for controlling the multi-view screen may be provided. According to an embodiment, in case the broadcasting content screen 1230 is included within the multi-view screen, a tap menu 1241 for the user to manually change a basic manipulation mode and a channel change mode may be provided together. Here, the basic manipulation mode may be a four direction manipulation mode, but is not limited thereto. The tap menu 1241 may include an indicator indicating the basic manipulation mode, e.g., a four direction manipulation mode, and an indicator indicating the channel change mode. According to an embodiment, while the pointer 10 is located on the content thumbnail screen 1210, the electronic device 100 may provide the four direction manipulation mode.

In case the pointer 10 moved to the broadcasting content screen 1230 according to a swipe input to the left direction in the four direction manipulation mode as illustrated in FIG. 12C, the electronic device 100 may provide the channel change mode. In this case, as illustrated in FIG. 12C, the indicator indicating the channel change mode included in the tap menu 1241 may be provided in a form distinguished from the indicator indicating the four direction manipulation mode so as to indicate that the mode was changed to the channel change mode. For example, the indicator indicating the channel change mode may be provided while being highlighted.

According to an embodiment, as illustrated in FIG. 12D, while a multi-view screen including the plurality of content screens 1220, 1230 is being provided at the external device 200, if a pinch zoom in input is received at the electronic device 100, the content screen 1220 on which the focus 10 is located may be enlarged and provided as a single screen. For example, if a multi-view screen including the plurality of content screens 1220, 1230 is provided at the external device 200, the external device 200 may transmit, to the electronic device 100, content information indicating that a multi-view screen is provided to the electronic device 100. In this case, when the pinch zoom 1250 in input is received, the electronic device 100 may transmit a control signal for changing the multi-view screen to a single screen to the external device 200.

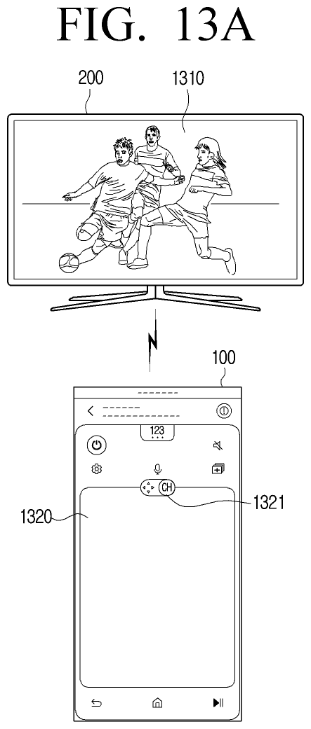

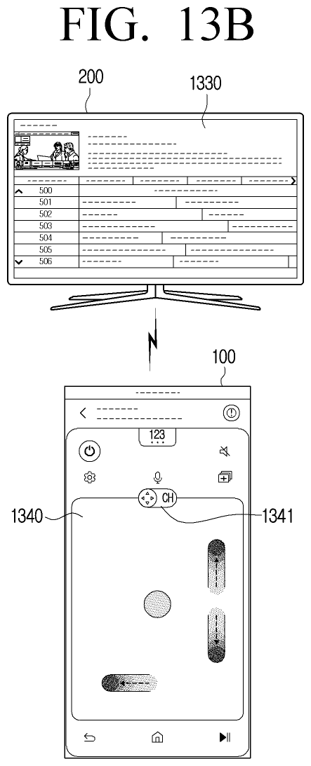

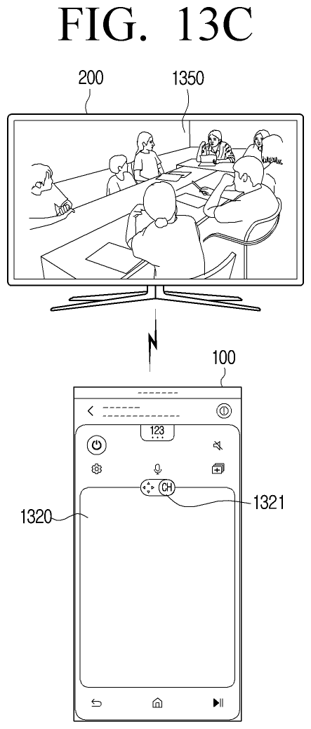

FIGS. 13A, 13B and 13C are diagrams illustrating an example method of converting a touch manipulation mode according to various embodiments.

According to various embodiments, if it is identified that a real time broadcasting content is being provided at the external device 200 based on the information on a content received from the external device 200, the electronic device 100 may provide a touch manipulation mode for manipulating the real time broadcasting content. If it is identified that a broadcasting program list is being provided at the external device 200 based on the information on the content received from the external device 200, the electronic device 100 may provide a touch manipulation mode for manipulating the broadcasting program list. For example, the touch manipulation mode for manipulating the real time broadcasting content and the touch manipulation mode for manipulating the broadcasting program list may generate control signals of different types for touch inputs of the same type. At least one of touch types that can be recognized in the touch manipulation mode for manipulating the real time broadcasting content and the touch manipulation mode for manipulating the broadcasting program list may be different.

According to an embodiment, as illustrated in FIG. 13A, while a broadcasting content screen 1310 is being provided at the external device 200, the electronic device 100 may provide a touch manipulation mode 1320 for a change of the channel. For example, as illustrated in FIG. 13A, a tap menu 1321 indicating that the current touch manipulation mode is a channel change mode may be provided.

According to an embodiment, if an EPG is executed at the external device 200 as illustrated in FIG. 13B, the external device 200 may transmit information indicating that an EPG screen 1330 is provided to the electronic device 100. In this case, as illustrated in FIG. 3B, the electronic device 100 may provide a four direction manipulation mode 1340 based on the information received from the external device 200. For example, as illustrated in FIG. 13B, a tap menu 1341 indicating that the current touch manipulation mode is a four direction manipulation mode may be provided.

According to an embodiment, if a broadcasting content is selected on the EPG screen 1330 provided on the external device 200 and a broadcasting content screen 1350 is provided on the external device 200 as illustrated in FIG. 13C, the external device 200 may transmit information indicating that the broadcasting content screen 1350 is provided to the electronic device 100. In this case, as illustrated in FIG. 13C, the electronic device 100 may provide the channel change mode 1320 based on the information received from the external device 200. For example, as illustrated in FIG. 13C, the tap menu 1321 indicating that the current touch manipulation mode is a channel change mode may be provided.

In case a content provided at the external device 200 is changed, the electronic device 100 to which the external device 200 transmits information on the changed content provides a touch manipulation mode based on the received information was explained, but the disclosure is not necessarily limited thereto. According to an embodiment, the electronic device 100 may convert a touch manipulation mode based on a control signal corresponding to a touch input. For example, in case the electronic device 100 transmitted a control signal selecting a broadcasting content to the external device 200, the electronic device 100 may identify that a broadcasting content screen will be provided at the external device 200, and thus the electronic device 100 may automatically change the touch manipulation mode to a channel change mode.

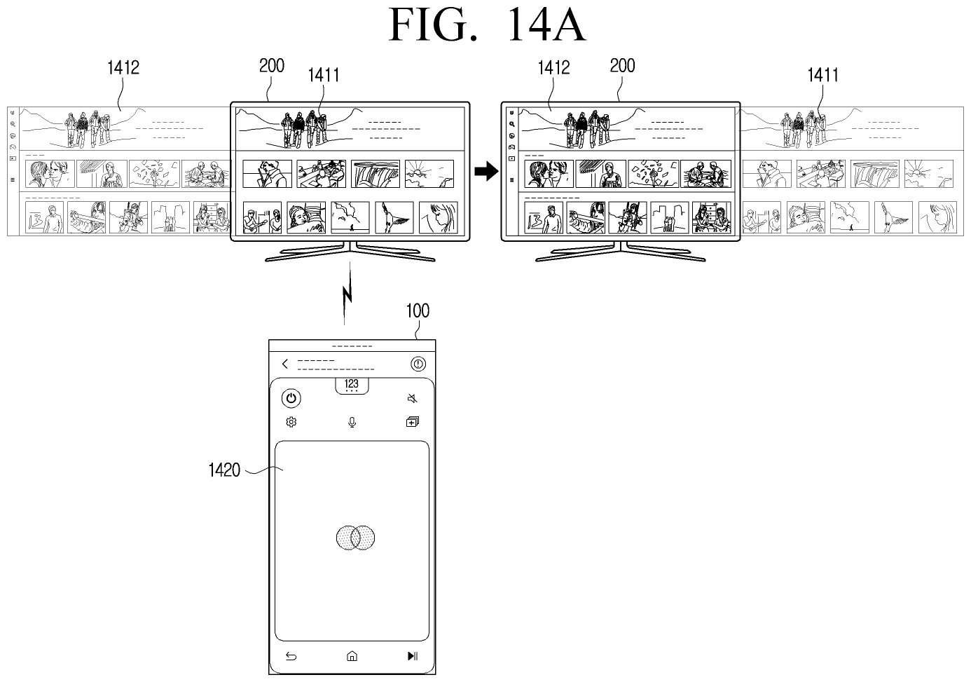

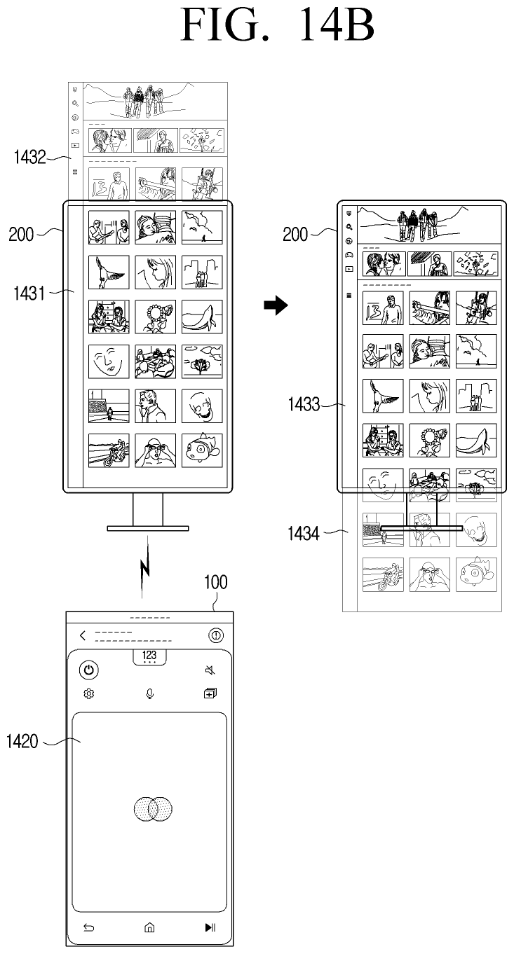

FIGS. 14A and 14B are diagrams illustrating an example method of manipulating scrolling in a touch manipulation mode according to various embodiments.

According to various embodiments, if it is identified that a screen that was scrolled by greater than or equal to a threshold range is being provided at the external device 200 based on information on a content received from the external device 200, and a touch input of a predetermined type is received, the electronic device 100 may transmit a control signal for restoring the scrolled screen to the original screen to the external device 200.

According to an embodiment, as illustrated on the left side of FIG. 14A, according to a scroll manipulation in the right direction in a horizontal display mode of the external device 200, a UI screen 1411 including GUI items listed in the right direction on the list may be provided. In this case, while the UI screen 1411 is being provided at the external electronic device 200, if a touch input of a predetermined type, e.g., a double tap input is received through a touch manipulation mode 1420 provided to the electronic device 100, a control signal for scrolling up the list may be transmitted to the external device 200. Accordingly, as illustrated on the right side of FIG. 14A, the original screen, e.g., a UI screen 1412 including GUI items listed in the left direction may be provided to the external device 200.

According to an embodiment, as illustrated on the left side of FIG. 14B, according to a scroll manipulation in the lower direction in a vertical display mode of the external device 200, a UI screen 1431 including GUI items listed in the lower direction on the list 1431, 1432 may be provided. In this case, while the UI screen 1431 is being provided at the external electronic device 200, if a touch input of the predetermined type, e.g., a double tap input is received through the touch manipulation mode 1420 provided to the electronic device 100, a control signal for scrolling up the list may be transmitted to the external device 200. Accordingly, as illustrated on the right side of FIG. 14B, the original screen, e.g., a UI screen 1433 including GUI items listed in the upper direction may be provided to the external device 200, and GUI items 1434 listed in the lower direction may disappear from the screen.

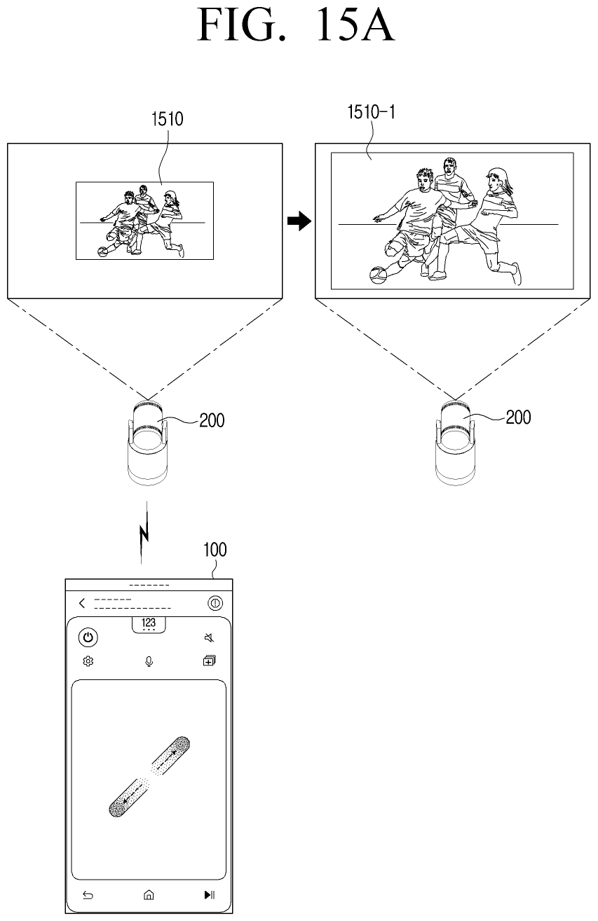

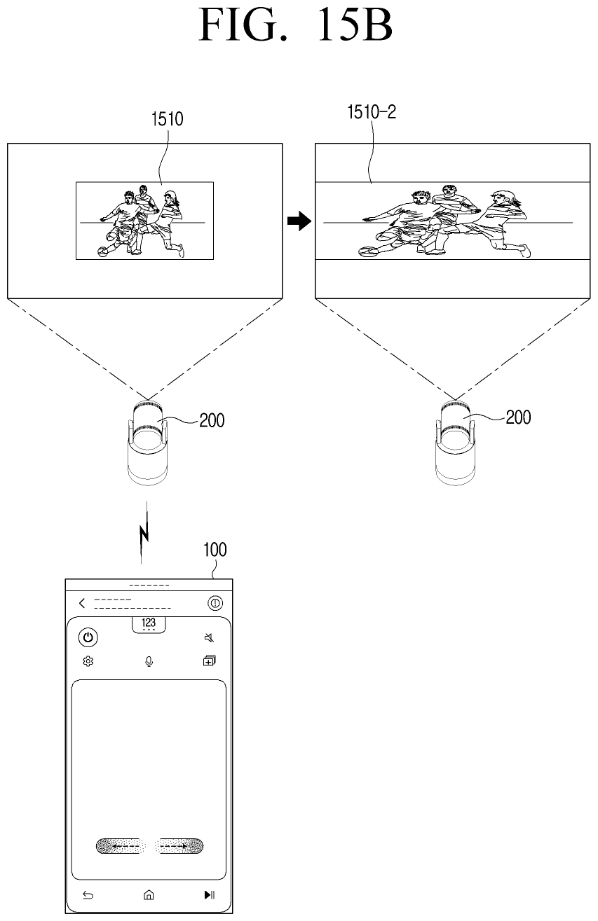

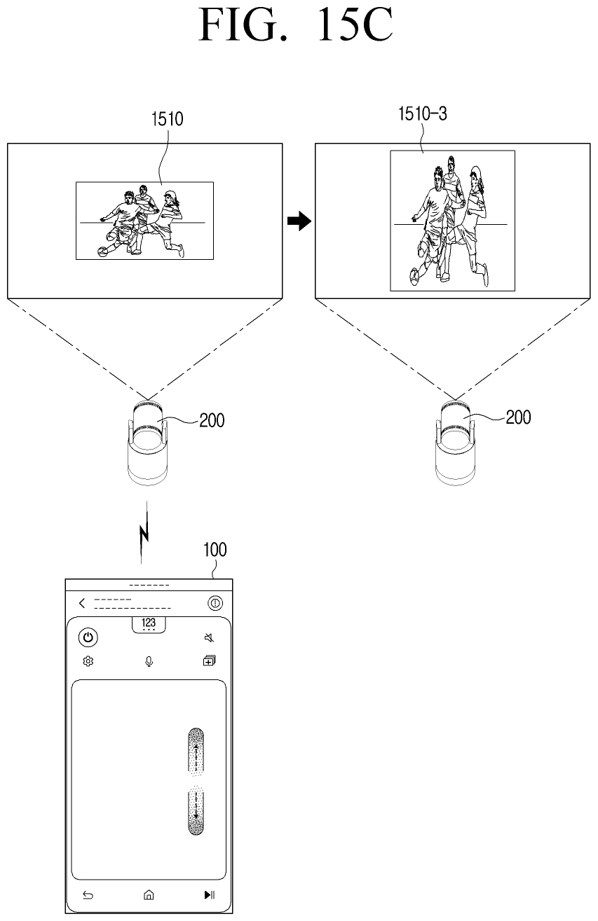

FIGS. 15A, 15B and 15C are diagrams illustrating an example method of manipulating a projector screen in a touch manipulation mode according to various embodiments.

According to various embodiments, if it is identified that the external device 200 is a projector device based on device information received from the external device 200, and a touch input of a predetermined type and a predetermined direction is received, the electronic device 100 may transmit a control signal for adjusting the size and/or the ratio of a screen provided by the projector device to correspond to the predetermined direction to the external device 200.

According to an embodiment, as illustrated in FIG. 15A, while the external device 200, e.g., the projector device is projecting a content screen 1510 on a projection surface, if a swipe and hold input is received at the electronic device 100 in a diagonal direction, the electronic device 100 may transmit a control signal for adjusting (enlarging or reducing) the size of the content screen 1510 in a diagonal direction to the external device 200, e.g., the projector device. In this case, the external device 200, e.g., the projector device may adjust the size and/or the ratio of the content screen 1510 projected on the projection surface in a diagonal direction, and project a content screen 1510-1 in an adjusted size on the projection surface.

According to an embodiment, as illustrated in FIG. 15B, while the external device 200, e.g., the projector device is projecting the content screen 1510 on the projection surface, if a swipe and hold input is received at the electronic device 100 in a left-right direction, the electronic device 100 may transmit a control signal for adjusting (enlarging or reducing) the size of the content screen 1510 in a left-right direction to the external device 200, e.g., the projector device. In this case, the external device 200, e.g., the projector device may adjust the size and/or the ratio of the content screen 1510 projected on the projection surface in a left-right direction, and project a content screen 1510-2 in an adjusted size on the projection surface.

According to an embodiment, as illustrated in FIG. 15C, while the external device 200, e.g., the projector device is projecting the content screen 1510 on the projection surface, if a swipe and hold input is received at the electronic device 100 in an up-down direction, the electronic device 100 may transmit a control signal for adjusting (enlarging or reducing) the size of the content screen 1510 in an up-down direction to the external device 200, e.g., the projector device. In this case, the external device 200, e.g., the projector device may adjust the size and/or the ratio of the content screen 1510 projected on the projection surface in an up-down direction, and project a content screen 1510-3 in an adjusted size on the projection surface.

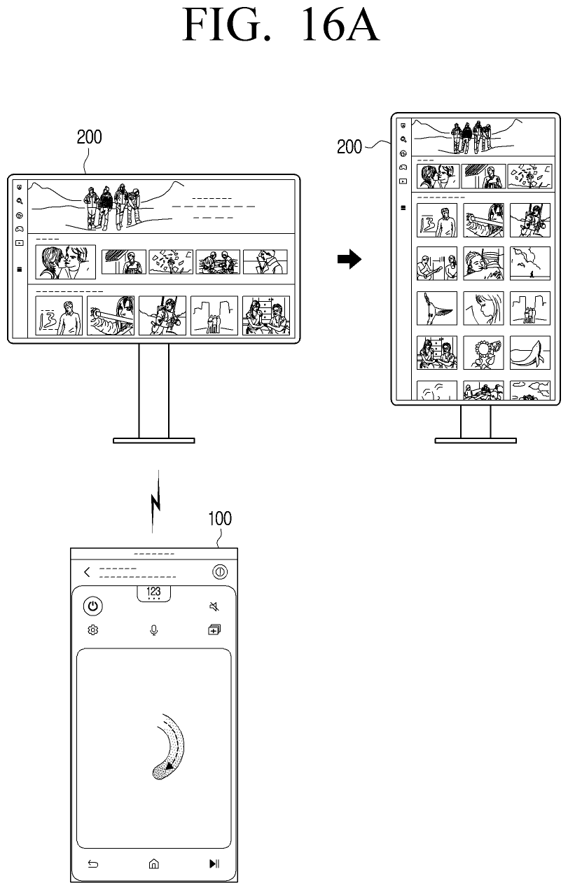

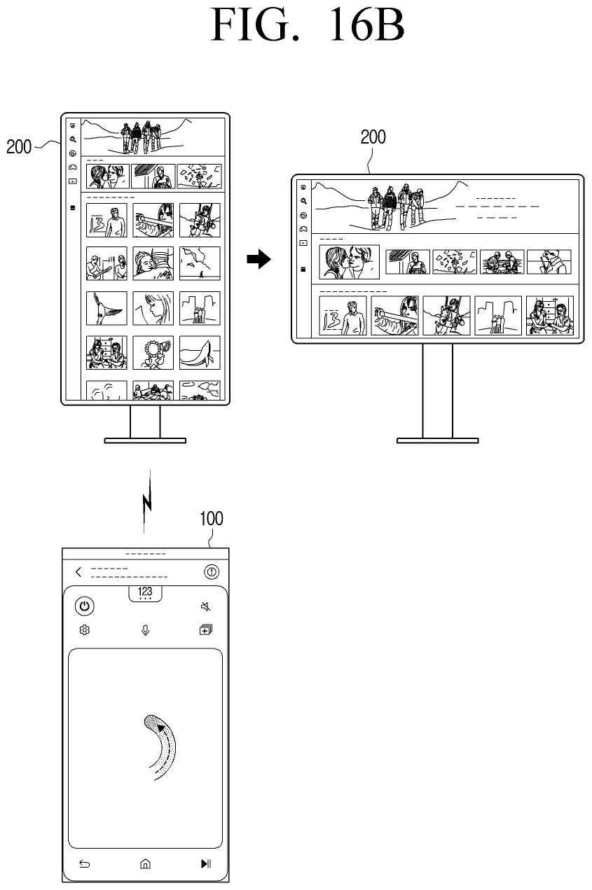

FIGS. 16A and 16B are diagrams illustrating an example method of manipulating a display mode of a display in a touch manipulation mode according to various embodiments.

According to various embodiments, the external device 200 may operate in one display mode from among a horizontal mode and a vertical mode. For example, the horizontal mode may be a display mode wherein the horizontal length of the display is longer than the vertical length. The vertical mode may be a display mode wherein the vertical length of the display is longer than the horizontal length. The horizontal mode may also be referred to as a horizontal direction posture mode or a landscape mode, and the vertical mode may also be referred to as a vertical direction posture mode or a portrait mode. According to an embodiment, the external device 200 may rotate the display using a pivot function. The display mode of the external device 200 does not operate only in the horizontal mode and the vertical mode, but may operate in a state of being tilted by a specific angle (e.g., a state of being tilted obliquely in a diagonal direction) according to a user instruction.

According to an embodiment, as illustrated in FIG. 16A, if a swipe and hold input is received in a clockwise direction while the external device 200 operates in the horizontal mode, the electronic device 100 may transmit a control signal for rotating the external device 200 in a clockwise direction and operating it in the vertical mode to the external device 200. In this case, the external device 200 gets to convert from the horizontal mode to the vertical mode by rotating the display. Accordingly, intuitive manipulation of the product becomes possible without pushing the rotation key separately.

According to an embodiment, as illustrated in FIG. 16B, if a swipe and hold input is received in a counter-clockwise direction while the external device 200 operates in the vertical mode, the electronic device 100 may transmit a control signal for rotating the external device 200 in a counter-clockwise direction and operating it in the horizontal mode to the external device 200. In this case, the external device 200 gets to convert from the vertical mode to the horizontal mode by rotating the display. Accordingly, intuitive manipulation of the product becomes possible without pushing the rotation key separately.

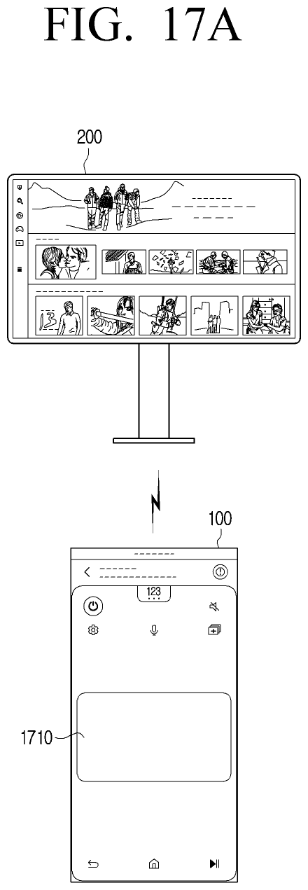

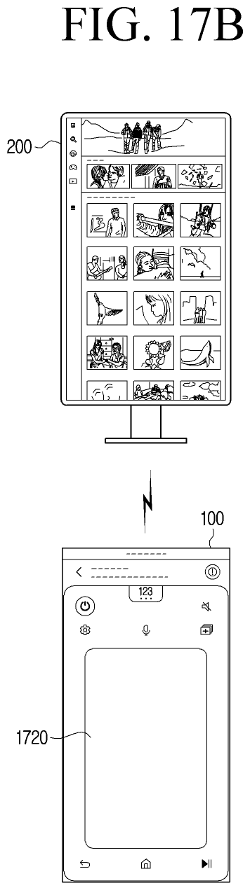

FIGS. 17A and 17B are diagrams illustrating an example method of providing a touch manipulation mode according to a display mode of a display according to various embodiments.

According to various embodiments, if mode information on the display mode of the external device 200 is received from the external device 200, the electronic device 100 may adjust the shape of a touch area wherein touch recognition is possible on the touch panel based on the received mode information, and provide the touch area. Here, the display mode may include a horizontal mode and a vertical mode.

For example, as illustrated in FIG. 17A, in case the external device 200 operates in the horizontal mode from among the horizontal mode and the vertical mode, the external device 200 may transmit information indicating that it is operating in the horizontal mode to the electronic device 100. In this case, the electronic device 100 may provide an area 1710 wherein touch recognition is possible in a horizontal shape as illustrated in FIG. 17A based on the received information.

For example, as illustrated in FIG. 17B, in case the external device 200 operates in the vertical mode from among the horizontal mode and the vertical mode, the external device 200 may transmit information indicating that it is operating in the vertical mode to the electronic device 100. In this case, the electronic device 100 may provide an area 1720 wherein touch recognition is possible in a vertical shape as illustrated in FIG. 17A based on the received information.

Intuitive experiences can be provided and gestures having high usability can be induced through consistency between the display mode of the external device 200 and the touch pad area.

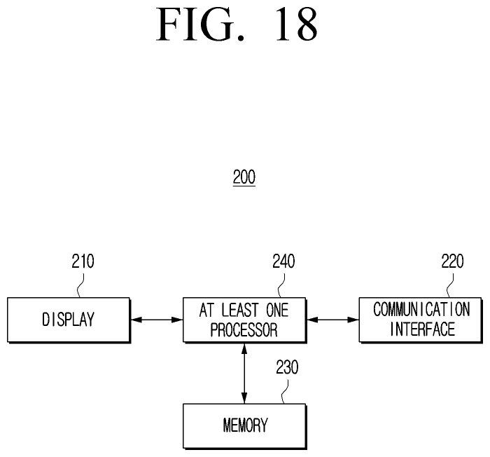

FIG. 18 is a block diagram illustrating an example configuration of an electronic device according to various embodiments.

According to FIG. 18, the electronic device 200 includes a display 210, a communication interface (e.g., including communication circuitry) 220, memory 230, and at least one processor (e.g., including processing circuitry) 240. As the implementation examples of the display 210, the communication interface 220, the memory 230, and the at least one processor 240 are identical/similar to the implementation examples of each of the display 210, the communication interface 220, the memory 230, and the at least one processor 240 illustrated in FIG. 2A, detailed explanation may not be repeated. According to various embodiments, the detailed configuration of the electronic device 200 may be identical/similar to the detailed configuration of the electronic device 100′ illustrated in FIG. 2B, and each component is identical/similar to the implementation examples of each of the components in FIG. 2B, and thus detailed explanation may not be repeated. According to an embodiment, in case the electronic device 200 is implemented as a TV, it may additionally include components for receiving broadcasting signals such as a tuner, a demodulator, etc.

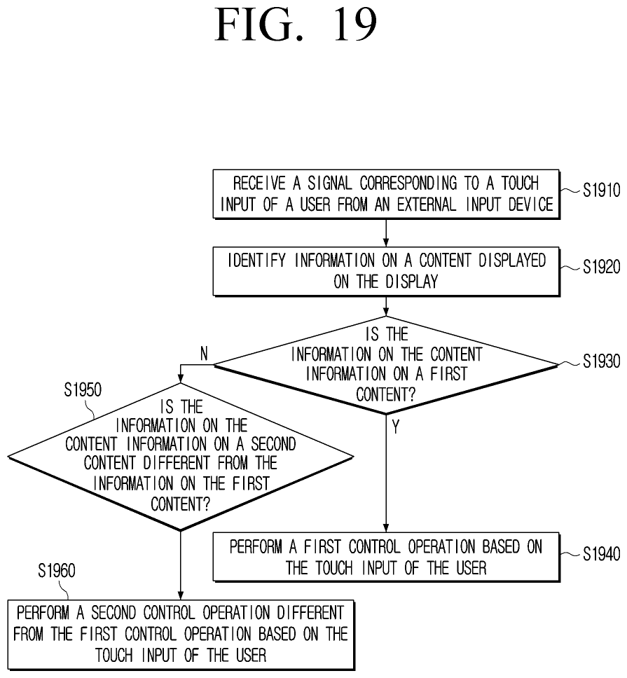

FIG. 19 is a flowchart illustrating an example operation of an electronic device according to various embodiments.

According to various embodiments, if a signal corresponding to a touch input of a user is received from an external input device in step S1910, at least one processor 240 (referred to as a processor 240 hereinafter) may identify information on a content displayed on the display in step S1920. According to an embodiment, the external input device (e.g., a remote control) may transmit only touch input information to the electronic device 200 (e.g., a TV), and the processor 240 may perform a control operation corresponding to the received touch input information (e.g., a touch coordinate) based on the information on the content provided at the electronic device 200.

A content may include various kinds of information related to an image provided on the screen of the external device 200 such as an application, a reproduced image, UI elements, etc. The information on the content may include information related to the type of the content, information related to the manipulation method of the content, and information on the configuration of the display of the content, and the provision state of the content, etc. For example, the information related to the type of the content may be information such as a user interface (UI) screen, an over the top (OTT) content screen, a web browser screen, a workspace screen, a real time broadcasting content screen, a VOD content reproduction screen, etc.

In case the information on the content is information on a first content in step S1930: Y, the processor 240 may perform a first control operation based on the touch input of the user in step S1940.

In case the information on the content is not information on the first content in step S1930: N, the processor 240 may identify whether the information is information on a second content different from the information on the first content in step S1950.

In case the information on the content is information on the second content different from the information on the first content in the step S1950: Y, the processor 240 may perform a second control operation different from the first control operation based on the touch input of the user in step S1960.

According to an embodiment, control information for each of a plurality of touch types corresponding to the information on the first content and control information for each of a plurality of touch types corresponding to the information on the second content may be stored in the memory 230. For example, the information stored in the memory 230 may be in a form of a look-up table, but is not necessarily limited thereto. For example, control information for each of a plurality of touch types according to the first touch manipulation mode explained as an example in FIG. 3A may have been stored in advance as control information corresponding to the first content information. For example, control information for each of a plurality of touch types according to the second touch manipulation mode explained as an example in FIG. 3B may have been stored in advance as control information corresponding to the second content information.

According to various embodiments, if a signal corresponding to the touch input of the user is continuously received from the external input device by a predetermined time interval, the processor 240 may identify the type of the touch input of the user based on information on a plurality of touch coordinates included in the continuously received signals. For example, the processor 240 may identify the type of the touch input of the user (e.g., swipe and hold, tap and hold, swipe, tap, flick, etc.) and/or the direction of the touch input based on the information on the plurality of touch coordinates included in the continuously received signals. For example, the processor 240 may identify the type and/or the direction of the touch input of the user based on touch coordinate values of signals received from the external input device by the predetermined interval. For example, the processor 240 may identify a touch drag form based on touch coordinate values that are continuously received. For example, in case the same touch coordinate value is continuously received during a specific time, the processor 240 may identify that tap inputs were received during the time on the location. According to an embodiment, if a touch input of a specific type is completed at the external input device, it may be possible to receive information corresponding to a plurality of touch coordinates and/or touch signals corresponding to the completed touch input. For example, the external input device may identify a touch type based on an identified touch coordinate, and transmit a signal corresponding to the identified touch type to the electronic device 200. In this case, the electronic device 200 may perform a control operation corresponding to the touch type included in the received signal based on the currently provided content.

According to various embodiments, in case information on the currently provided content includes information on a plurality of contents having different manipulation attributes, the processor 240 may perform a control operation corresponding to the touch input of the user based on information on a content wherein a selection GUI is located.

According to various embodiments, if it is identified that a real time broadcasting content is being provided currently, the processor 240 may perform a first control operation based on the identified type of the touch input of the user. Also, if it is identified that a broadcasting program list is being provided currently, the processor 240 may perform a second control operation different from the first control operation based on the identified type of the touch input of the user. That is, the processor 240 may perform different control operations according to the currently provided content even if the types of touch inputs of the user are the same.

According to various embodiments, if it is identified that a screen that was scrolled by greater than or equal to a threshold range is being provided currently, and the touch input of the user is identified as a touch input of a predetermined type, the processor 240 may perform a control operation of restoring the scrolled screen to the original screen.

According to various embodiments, if it is identified that a single screen is being provided currently, and the touch input of the user is identified as a touch input of a first type, the processor 240 may perform a control operation of changing the single screen to a multi-view screen. Also, if it is identified that a multi-view screen is being provided currently, and the touch input of the user is identified as a touch input of a second type, the processor 240 may perform a control operation of changing the multi-view screen to a single screen.

As example embodiments related to control operations performed at the electronic device 200 according to contents provided at the electronic device 200 and types of user inputs explained in FIG. 18 and FIG. 19 may be identical/similar to example embodiments illustrated in FIG. 1 to FIG. 17, detailed explanation will be omitted. For example, there may be a difference in that, in FIG. 1 to FIG. 17, a first electronic device 100 (e.g., an input device) receives information on a content provided at the electronic device 200 (e.g., a display device), and identifies a control signal by itself based on the information, and transmits the signal to the electronic device 200, but in the case of example embodiments illustrated in FIG. 18 and FIG. 19, the processor 240 identifies control information based on a content provided at the electronic device 200 and touch input information received from the electronic device 100, and performs a control operation, and the example embodiments related to detailed control operations performed at the electronic device 200 may be identical/similar.

According to the aforementioned various embodiments, as a mobile device provides a corresponding touch manipulation mode according to a content provided at an external device, the user can intuitively control the external device without viewing the screen of the mobile device. Accordingly, UX experiences of the user can be improved.

Methods according to the aforementioned various embodiments of the disclosure may be implemented just with software upgrade, or hardware upgrade of conventional electronic devices.

The aforementioned various embodiments of the disclosure may be performed through an embedded server provided on an electronic device, or an external server of an electronic device.

According to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or using other components under its control. An instruction may include a code that is generated or executed by a compiler or an interpreter. A storage medium that is readable by machines may be provided in the form of a non-transitory storage medium. Here, the ‘non-transitory’ storage medium may not include a signal, and is tangible, and the term does not distinguish a case wherein data is stored in the storage medium semi-permanently and a case wherein data is stored temporarily.

According to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components (e.g.: a module or a program) according to the aforementioned various embodiments may include a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform functions performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

While various example embodiments of the disclosure have been shown and described, the disclosure is not limited to the aforementioned example embodiments, and it is apparent that various modifications may be made by those having ordinary skill in the technical field to which the disclosure belongs, without departing from the gist of the disclosure including the appended claims. Further, it is intended that such modifications are not to be interpreted independently from the technical idea or prospect of the disclosure. It will also be understood that any of the embodiment(s) described herein may be used in connection with any other embodiment(s) described herein.

What is claimed is:

1. An electronic device comprising:
a display;
a communication interface comprising communication circuitry;
memory configured to store at least one instruction; and
at least one processor, comprising processing circuitry, connected with the display, the communication interface, and the memory,
wherein at least one processor, individually and/or collectively, is configured to execute the at least one instruction and to cause the electronic device to:
based on receiving a signal corresponding to a touch input from an external input device through the communication interface, identify information on a content displayed on the display,
based on the information on the content being information on a first content, perform a first control operation based on the touch input, and
based on the information on the content being information on a second content different from the information on the first content, perform a second control operation different from the first control operation based on the touch input.

2. The electronic device of claim 1,
wherein at least one processor, individually and/or collectively, is configured to cause the electronic device to:
based on continuously receiving a signal corresponding to the touch input by a specified time interval, identify the type of the touch input based on information on a plurality of touch coordinates included in the continuously received signals,
perform the first control operation based on the identified type of the touch input and the information on the first content, and
perform the second control operation based on the identified type of the touch input and the information on the second content.

3. The electronic device of claim 1,
wherein at least one processor, individually and/or collectively, is configured to cause the electronic device to:
based on the information on the content including information on a plurality of contents having different manipulation attributes, perform a control operation corresponding to the touch input based on information on a content wherein a selection GUI is located.

4. The electronic device of claim 1,
wherein at least one processor, individually and/or collectively, is configured to cause the electronic device to:
based on a real time broadcasting content being provided currently and the identified type of the touch input being identified as a swipe input, perform channel control based on the swipe input, and
based on a web browser screen or a broadcasting program list being provided currently and the identified type of the touch input being identified as the swipe input, control a location of a pointer displayed on the display based on the swipe input.

5. The electronic device of claim 1,
wherein at least one processor, individually and/or collectively, is configured to cause the electronic device to:
based on identifying that a screen that was scrolled by greater than or equal to a threshold range being provided currently, and the touch input being identified as a touch input of a specified type, perform a control operation of restoring the scrolled screen to the original screen.

6. The electronic device of claim 1,
wherein at least one processor, individually and/or collectively, is configured to cause the electronic device to:
based on identifying that a single screen is being provided currently, and the touch input being identified as a touch input of a first type, perform a control operation of changing the single screen to a multi-view screen, and
based on identifying that a multi-view screen is being provided currently, and the touch input being identified as a touch input of a second type, perform a control operation of changing the multi-view screen to a single screen.

7. An electronic device comprising:
a display including a touch panel;
a communication interface comprising communication circuitry;
memory configured to store at least one instruction; and
at least one processor, comprising processing circuitry, connected with the display, the communication interface, and the memory,
wherein at least one processor, individually and/or collectively, is configured to execute the at least one instruction and to cause the electronic device to:
receive information on a content provided at an external device through the communication interface,
based on receiving a touch input through the touch panel, identify control information corresponding to the touch input based on the information on the content, and
transmit a control signal corresponding to the identified control information to the external device through the communication interface.

8. The electronic device of claim 7,
wherein at least one processor, individually and/or collectively, is configured to cause the electronic device to:
provide at least one touch manipulation mode among a plurality of different touch manipulation modes based on the information on the content, and
the plurality of different touch manipulation modes comprise:
at least one of modes of which recognizable touch types are different or modes which generate different control signals for the same touch input type.

9. The electronic device of claim 8,
wherein at least one processor, individually and/or collectively, is configured to:
based on information on a content received from the external device including information on a plurality of contents having different manipulation attributes, provide a first touch manipulation mode corresponding to any one of the plurality of contents through the touch pad, and control the display to provide a GUI menu for changing the first touch manipulation mode to a second touch manipulation mode corresponding to another one of the plurality of contents, and
the first touch manipulation mode and the second touch manipulation mode including modes that generate control signals of different types for touch inputs of the same type.

10. The electronic device of claim 8,
wherein the memory is configured to:
store information on a first control signal corresponding to a touch input of a first type in the first touch manipulation mode and information on a second control signal corresponding to a touch input of the first type in the second touch manipulation mode, and
store information on a third control signal corresponding to a touch input of a second type in the second touch manipulation mode and information on a fourth control signal corresponding to a touch input of the second type in the second touch manipulation mode, and
at least one processor, individually and/or collectively, is configured to cause the electronic device to:
based on receiving a touch input of the first type in the first touch manipulation mode, transmit the first control signal to the external device through the communication interface, and based on receiving a touch input of the second type, transmit the second control signal to the external device through the communication interface, and
based on receiving a touch input of the first type in the second touch manipulation mode, transmit the third control signal to the external device through the communication interface, and based on receiving a touch input of the second type, transmit the fourth control signal to the external device through the communication interface.

11. The electronic device of claim 7,
wherein at least one processor, individually and/or collectively, is configured to cause the electronic device to:
based on receiving a specified signal from the external device, provide a GUI menu for entering a touch manipulation mode,
based on receiving an instruction through the GUI menu, request information for provision of a touch manipulation mode to the external device, and
based on receiving device information and the information on the content from the external device according to the request, control the display to provide a touch manipulation mode corresponding to the device information and the information on the content.

12. The electronic device of claim 7,
wherein at least one processor, individually and/or collectively, is configured to cause the electronic device to:
based on identifying that a real time broadcasting content is being provided at the external device based on the information on the content, control the display to provide a touch manipulation mode for manipulating the real time broadcasting content, and
based on identifying that a broadcasting program list is being provided at the external device based on the information on the content, control the display to provide a touch manipulation mode for manipulating the broadcasting program list, and
the touch manipulation mode for manipulating the real time broadcasting content and the touch manipulation mode for manipulating the broadcasting program list include modes that generate control signals of different types for touch inputs of the same type.

13. The electronic device of claim 7,
wherein at least one processor, individually and/or collectively, is configured to cause the electronic device to:
based on identifying that a screen scrolled by greater than or equal to a threshold range is being provided at the external device based on the information on the content, and based on receiving a touch input of a specified type through the touch panel, transmit a control signal for restoring the scrolled screen to the original screen to the external device through the communication interface.

14. The electronic device of claim 7,
wherein at least one processor, individually and/or collectively, is configured to cause the electronic device to:
based on identifying that a single screen is being provided at the external device based on the information on the content, and based on receiving a touch input of a specified first type through the touch panel, transmit a control signal for changing the single screen to a multi-view screen to the external device through the communication interface, and
based on identifying that a multi-view screen is being provided at the external device based on the information on the content, and based on receiving a touch input of a specified second type through the touch panel, transmit a control signal for changing the multi-view screen to a single screen to the external device through the communication interface.

15. A method of operating an electronic device comprising a touch panel, the method comprising:
receiving information on a content provided at an external device from the external device;
based on receiving a touch input through the touch panel, identifying control information corresponding to the touch input based on the information on the content; and
transmitting a control signal corresponding to the identified control information to the external device.

16. The method of claim 15, wherein the identifying the control information corresponding to the touch input comprises:
providing at least one touch manipulation mode among a plurality of different touch manipulation modes based on the information on the content, and
the plurality of different touch manipulation modes comprise:
at least one of modes of which recognizable touch types are different or modes which generate different control signals for the same touch input type.

17. The method of claim 16, wherein the providing the at least one touch manipulation mode comprises:
based on information on a content received from the external device including information on a plurality of contents having different manipulation attributes, providing a first touch manipulation mode corresponding to any one of the plurality of contents through the touch pad, and providing a GUI menu for changing the first touch manipulation mode to a second touch manipulation mode corresponding to another one of the plurality of contents, and
the first touch manipulation mode and the second touch manipulation mode including modes that generate control signals of different types for touch inputs of the same type.

18. The method of claim 16, wherein the electronic device is configured to:
store information on a first control signal corresponding to a touch input of a first type in the first touch manipulation mode and information on a second control signal corresponding to a touch input of the first type in the second touch manipulation mode, and
store information on a third control signal corresponding to a touch input of a second type in the second touch manipulation mode and information on a fourth control signal corresponding to a touch input of the second type in the second touch manipulation mode, and
wherein the transmitting the control signal corresponding to the identified control information comprises:
based on receiving a touch input of the first type in the first touch manipulation mode, transmitting the first control signal to the external device, and based on receiving a touch input of the second type, transmitting the second control signal to the external device, and
based on receiving a touch input of the first type in the second touch manipulation mode, transmitting the third control signal to the external device, and based on receiving a touch input of the second type, transmitting the fourth control signal to the external device.

19. The method of claim 15, further comprises:
based on receiving a specified signal from the external device, providing a GUI menu for entering a touch manipulation mode,
based on receiving an instruction through the GUI menu, requesting information for provision of a touch manipulation mode to the external device, and
based on receiving device information and the information on the content from the external device according to the request, providing a touch manipulation mode corresponding to the device information and the information on the content.

20. The method of claim 15, further comprises:
based on identifying that a real time broadcasting content is being provided at the external device based on the information on the content, providing a touch manipulation mode for manipulating the real time broadcasting content, and
based on identifying that a broadcasting program list is being provided at the external device based on the information on the content, providing a touch manipulation mode for manipulating the broadcasting program list, and
the touch manipulation mode for manipulating the real time broadcasting content and the touch manipulation mode for manipulating the broadcasting program list include modes that generate control signals of different types for touch inputs of the same type.
